(19) United States
(12) Patent Application Publication
(10) Pub. No.: US 2001/0010173 A1
(43) Pub. Date: Aug. 2, 2001

(54) Piezo-electric vibration gyroscope

(75) Inventors: Takeshi Inoue, Tokyo (JP); Mitsuru Yamamoto, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/772,010

(22) Filed: Jan. 29, 2001

(30) Foreign Application Priority Data
Jan. 28, 2000 (JP) 2000-020592

(51) Int. Cl. G01P 3/44; G01P 15/08

(52) U.S. Cl. 73/504.16; 73/514.34

(57) ABSTRACT

The present invention provides a piezo-electric vibration gyroscope comprising: a body of a rectangle plate shape defined by a first size in a length direction and a second size in a width direction; plural driver arms extending from a first side of the body in the length direction and also extending in the same plane as the body; plural detective arms extending from a second side opposite to the first side of the body in an anti-parallel direction to the length direction and also extending in the same plane as the body; plural driver electrodes being provided on the plural driver arms and being applied with an alternating current voltage for causing the plural driver electrodes to show an in-plane vibration of a driving mode in the width direction included in the plane; plural detecting electrodes on at least one of the plural detective arms for detecting a voltage caused by a vertical-to-plane vibration of a detective mode in a vertical direction to the plane, wherein the first size of the body is equal to or larger than the second size of the body for allowing the vertical-to-plane vibration of the detective mode to propagate from the plural driver arms through the body to the plural detective electrodes and for preventing the in-plane vibration of the driving mode from propagating from the plural driver arms through the body to the plural detective electrodes.

### BACKGROUND OF THE INVENTION

The present invention relates to a piezo-electric vibration gyroscope, and a method of adjusting a vibration frequency of piezo-electric vibration gyroscope.

The vibration gyroscope is to measure an angular velocity of a rotating object by utilizing a phenomenon that the Coriolis force is applied to a resonating object on a rotating object in a direction perpendicular to an angular velocity vector thereof. The vibration gyroscope has widely been used to confirm a position of a moving object, for example, airplanes, ships, and space satellites. In recent years, the vibration gyroscope has also been used for car-navigation system, attitude control system for automobile, VTR camera, hand-fluctuation detecting system for devices such as cameras. In accordance with the piezo-electric vibration gyroscope, a driving voltage is applied to excite a driving vibration, whereby a detective vibration caused by the Coriolis force is then converted into electric signals by the piezo-electric device. Such the piezo-electric vibration gyroscope may, for example, be a Sperry tuning fork gyroscope, a Watson tuning fork gyroscope, a tuning fork gyroscope, and a cylindrical vibration gyroscope.

In recent years, a tuning fork piezo-electric gyroscope showing high performance is disclosed in Japanese laid-open patent publication No. 8-128830, wherein the piezo-electric gyroscope comprises a lithium tantalate piezo-electric single crystal. FIG. 1 is a schematic perspective view illustrative of a conventional lithium tantalate tuning fork piezo-electric vibration gyroscope to explain an in-plane vibration thereof. FIG. 2 is a schematic perspective view illustrative of a conventional lithium tantalate tuning fork piezo-electric vibration gyroscope to explain an vertical-to-plane vibration thereof. The conventional lithium tantalate tuning fork piezo-electric vibration gyroscope comprises a right arm 101, a left arm 102 and a base 103 connecting between the right and left arms 101 and 102, so that the right and left arms 101 and 102 and the base 103 forms a tuning fork, namely U-shape. An electrode, which is not illustrated, is provided inside of each of the right and left arms 101 and 102.

Operations of the conventional tuning fork piezo-electric vibration gyroscope 100 will be described. A voltage is applied to the right electrode in the right arm 101 to cause an in-plane vibration of the right arm 101, wherein the right arm 101 is vibrated in right-left directions included in a main face or a front face of the conventional tuning fork piezo-electric vibration gyroscope 100. This in-plane vibration of the right arm 101 is propagated to the lift arm 102, whereby the left arm 102 shows a resonant vibration to the vibration of the right arm 101. In the resonant vibration of the right and left arms 101 and 102, the right and left arms 101 and 102 show alternating first and second displacements. In the first displacement, the right and left arms 101 and 102 move in inside anti-parallel directions toward a center between the right and left arms 101 and 102. In the second displacement, the right and left arms 101 and 102 move in outside anti-parallel directions opposite to the center between the right and left arms 101 and 102. This in-plane vibration is one of the natural vibration modes of the tuning fork piezo-electric vibration gyroscope 100. In this example, this is the driving vibration mode. If the tuning fork piezo-electric vibration gyroscope 100 is placed on a rotating object which rotates at an angular velocity Ω around an axis “Z”, along which the right and left arms 101 and 102 extend, then the anti-parallel Coriolis forces “Fc” are applied to the right and left arms 101 and 102 in anti-parallel directions to each other and vertical to the directions of the in-plane vibration or vertical to the main face of the tuning fork piezo-electric vibration gyroscope 100. The right and left arms 101 and 102 show alternating vertical-to-plane vibrations, wherein the right and left arms 101 and 102 vibrate in the anti-parallel directions to each other and vertical to the main face of the tuning fork piezo-electric vibration gyroscope 100. This vertical-to-plane vibration is one of the natural vibration modes of the tuning fork piezo-electric vibration gyroscope 100. The above in-plane vibration is the driving vibration mode, whilst the vertical-to-plane vibration is the detecting vibration mode. The vertical-to-plane vibration as the detecting mode vibration is detected to be a potential difference of the electrode provided in the left arm 102 for the purpose of measuring the angular velocity o the rotating object around the axis “Z”.

The above conventional tuning fork piezo-electric vibration gyroscope 100 has the following problems. The above conventional tuning fork piezo-electric vibration gyroscope 100 shows not only the vertical-to-plane vibration as the detecting mode vibration on the left arm 102 but also the in-plane vibration as the driving vibration mode. The two vibration modes are chemically coupled to each other. This mechanical coupling causes a noise vibration which acts as a noise to the detection. Namely, the mechanical coupling between the two vibration modes deteriorates a signal-to-noise ratio in detecting operation. Further, a short distance between the driving electrode in the right arm 101 and the detecting electrode in the left arm 102 causes an electrostatic coupling between the voltage applied to the driving electrode and the detecting signal of the detecting electrode. This electrostatic coupling further deteriorates the signal-to-noise ratio. The tuning fork piezo-electric vibration gyroscope 100 is hard to adjust the frequencies of the vertical-to-plane vibration mode and the in-plane vibration mode. Whereas it is preferable to support the tuning fork piezo-electric vibration gyroscope 100 at its gravity center in view of a possible highly stable support, the vibration appears on the gravity center of the tuning fork piezo-electric vibration gyroscope 100, whereby this support at the gravity center causes a large loss to the vibration of the tuning fork piezo-electric vibration gyroscope 100. In view of allowing the tuning fork piezo-electric vibration gyroscope 100 to show the intended or necessary vibration, it is impossible to support the tuning fork piezo-electric vibration gyroscope 100 at the gravity center. It is extremely difficult to support the piezo-electric device at its vibration node.

In the above circumstances, it had be en required to develop a novel piezo-electric vibration gyroscope free from the above problem.

### SUMMARY OF THE INVENTION

Accordingly, it is an object of the present invention to provide a novel piezo-electric vibration gyroscope free from the above problems.

It is a further object of the present invention to provide a novel piezo-electric vibration gyroscope suitable for packaging a vibrator.

It is a still further object of the present invention to provide a novel piezo-electric vibration gyroscope having a high sensitivity in detection to a detective vibration caused by the Coriolis force.

It is yet a further object of the present invention to provide a novel piezo-electric vibration gyroscope having a high resolution.

The present invention provides a piezo-electric vibration gyroscope comprising: a body of a rectangle plate shape defined by a first size in a length direction and a second size in a width direction; plural driver arms extending from a first side of the body in the length direction and also extending in the same plane as the body; plural detective arms extending from a second side opposite to the first side of the body in an anti-parallel direction to the length direction and also extending in the same plane as the body; plural driver electrodes being provided on the plural driver arms and being applied with an alternating current voltage for causing the plural driver electrodes to show an in-plane vibration of a driving mode in the width direction included in the plane; plural detecting electrodes on at least one of the plural detective arms for detecting a voltage caused by a vertical-to-plane vibration of a detective mode in a vertical direction to the plane, wherein the first size of the body is equal to or larger than the second size of the body for allowing the vertical-to-plane vibration of the detective mode to propagate from the plural driver arms through the body to the plural detective electrodes and for preventing the in-plane vibration of the driving mode from propagating from the plural driver arms through the body to the plural detective electrodes.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a schematic perspective view illustrative of a conventional lithium tantalate tuning fork piezo-electric vibration gyroscope to explain an in-plane vibration thereof.

FIG. 2 is a schematic perspective view illustrative of a conventional lithium tantalate tuning fork piezo-electric vibration gyroscope to explain an vertical-to-plane vibration thereof.

FIG. 3 is a schematic perspective view illustrative of a first novel six-armed piezo-electric vibration gyroscope in a first embodiment in accordance with the present invention.

FIG. 4A is a top view illustrative of driver electrodes of the first novel six-armed piezo-electric vibration gyroscope of FIG. 3 in a first embodiment in accordance with the present invention.

FIG. 4B is a front view illustrative of a detective electrode and driver electrodes of the first novel six-armed piezo-electric vibration gyroscope of FIG. 3 in a first embodiment in accordance with the present invention.

FIG. 4C is a bottom view illustrative of a detective electrode of the first novel six-armed piezo-electric vibration gyroscope of FIG. 3 in a first embodiment in accordance with the present invention.

FIG. 5 is a diagram illustrative of connections involving driver electrodes of the first novel six-armed piezo-electric vibration gyroscope of FIG. 3 in a first embodiment in accordance with the present invention.

FIG. 6 is a diagram illustrative of connections involving a detective electrode of the first novel six-armed piezo-electric vibration gyroscope of FIG. 3 in a first embodiment in accordance with the present invention.

FIG. 7 is a schematic perspective view illustrative of a first novel six-armed piezo-electric vibration gyroscope showing the in-plane vibrations of the three driver arms in a first embodiment in accordance with the present invention.

FIG. 8 is a schematic perspective view illustrative of a first novel six-armed piezo-electric vibration gyroscope showing the vertical-to-plane vibrations of the center detective arm in a first embodiment in accordance with the present invention.

FIG. 9A is a side view illustrative of a driver arm as considered to be a one-side supported beam of the six-armed piezo-electric vibration gyroscope in a first embodiment in accordance with the present invention.

FIG. 9B is a top view illustrative of a top of the driver arm as considered to be a one-side supported beam in FIG. 9A.

FIG. 10 is a diagram illustrative of variations in the effective electromechanical coupling coefficient as a relative value versus the ratio “Le”/“La”, provided that the ratio “We”/“Wa” is kept constant at 0.7.

FIG. 11 is a diagram illustrative of variations in the effective electromechanical coupling coefficient as a relative value versus the ratio “We”/“Wa”, provided that the ratio “Le”/“La” is kept constant at 0.6.

FIG. 12A is a side view illustrative of a detective arm as considered to be a one-side supported beam of the six-armed piezo-electric vibration gyroscope in a first embodiment in accordance with the present invention.

FIG. 12B is a top view illustrative of a top of the detective arm as considered to be a one-side supported beam in FIG. 12A.

FIG. 13 is a diagram illustrative of variations in the effective electromechanical coupling coefficient as a relative value versus the ratio “Lev”/“Lav”, provided that the ratio “Wev”/“Wav” is kept constant at 0.5.

FIG. 14 is a diagram illustrative of variations in the effective electromechanical coupling coefficient as a relative value versus the ratio “Wev”/“Wav”, provided that the ratio “Lev”/“Lav” is kept constant at 0.6.

FIG. 15 is a schematic side view illustrative of a six-armed piezo-electric vibration gyroscope supported by a supporter at a position of gravity center in a first embodiment in accordance with the present invention.

FIG. 16 is a schematic perspective view illustrative of a second novel six-armed piezo-electric vibration gyroscope in a second embodiment in accordance with the present invention.

FIG. 17A is a top view illustrative of driver electrodes of the second novel six-armed piezo-electric vibration gyroscope of FIG. 16 in a second embodiment in accordance with the present invention.

FIG. 17B is a front view illustrative of a detective electrode and driver electrodes of the second novel six-armed piezo-electric vibration gyroscope of FIG. 16 in a second embodiment in accordance with the present invention.

FIG. 17C is a bottom view illustrative of a detective electrode of the second novel six-armed piezo-electric vibration gyroscope of FIG. 16 in a second embodiment in accordance with the present invention.

FIG. 18 is a diagram illustrative of connections involving driver electrodes of the second novel six-armed piezo-electric vibration gyroscope of FIG. 16 in a second embodiment in accordance with the present invention.

FIG. 19 is a diagram illustrative of connections involving a detective electrode of the second novel six-armed piezo-electric vibration gyroscope of FIG. 16 in a second embodiment in accordance with the present invention.

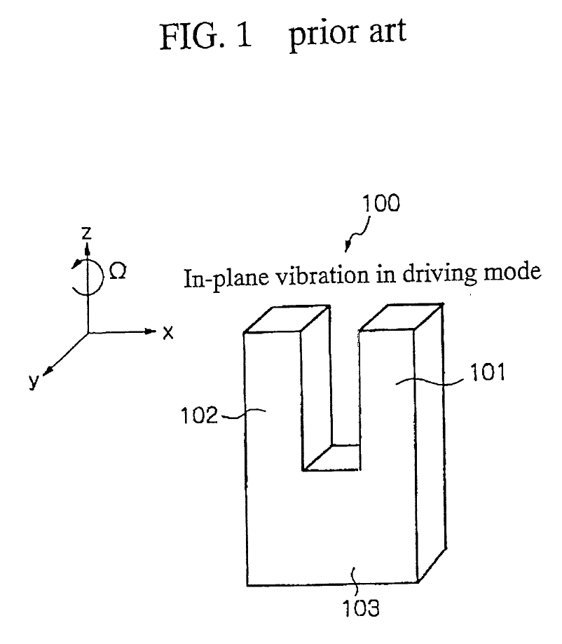

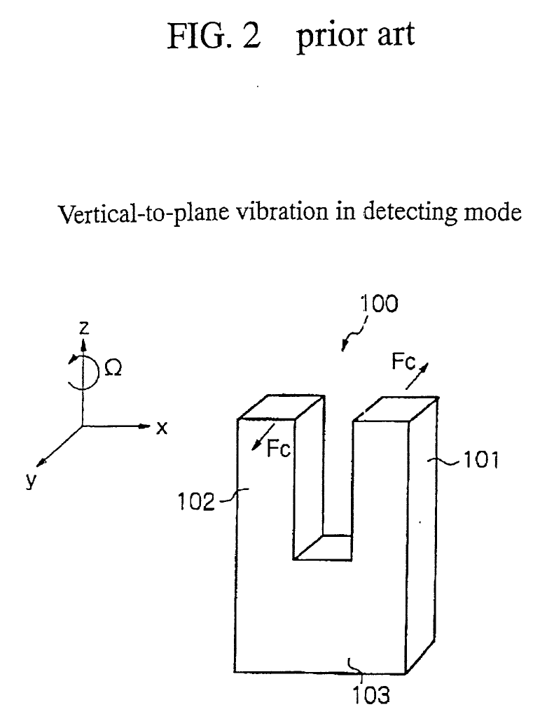

### DISCLOSURE OF THE INVENTION

The first present invention provides a piezo-electric vibration gyroscope comprising: a body of a rectangle plate shape defined by a first size in a length direction and a second size in a width direction; plural driver arms extending from a first side of the body in the length direction and also extending in the same plane as the body; plural detective arms extending from a second side opposite to the first side of the body in an anti-parallel direction to the length direction and also extending in the same plane as the body; plural driver electrodes being provided on the plural driver arms and being applied with an alternating current voltage for causing the plural driver electrodes to show an in-plane vibration of a driving mode in the width direction included in the plane; plural detecting electrodes on at least one of the plural detective arms for detecting a voltage caused by a vertical-to-plane vibration of a detective mode in a vertical direction to the plane, wherein the first size of the body is equal to or larger than the second size of the body for allowing the vertical-to-plane vibration of the detective mode to propagate from the plural driver arms through the body to the plural detective electrodes and for preventing the in-plane vibration of the driving mode from propagating from the plural driver arms through the body to the plural detective electrodes.

It is preferable that the body has a higher stiffness in the same direction as the in-plane vibration than other stiffness in other directions.

It is also preferable that the number of the plural driver arms is the same as the number of the plural detective arms.

It is further preferable that the piezo-electric vibration gyroscope is symmetrical both in the length direction and the width direction.

It is further more preferable that a center driver arm in the plural driver arms and a center detective arm in the plural detective arms are aligned on a longitudinal center axis parallel to the length direction.

It is also preferable that the plural driver arms and the plural detective arms have the same length.

It is also preferable that the plural driver arms comprise three driver arms and the plural detective arms comprise three detective arms.

It is further preferable that a center driver arm in the three driver arms and a center detective arm in the three detective arms are aligned on a longitudinal center axis parallel to the length direction.

It is also preferable that the three driver arms and the three detective arms have the same length and have the same width.

It is also preferable that four driver electrodes are provided on front and back main faces and right and left side faces of each of the three driver arms, and first-paired detective electrodes are provided on a front face of the center detective electrode and second-pared detective electrodes are provided on a back face of the center detective electrode.

It is further preferable that each of the driver electrodes has a longitudinal center axis which is aligned to a longitudinal center axis of the driver arm, and each of the driver electrodes has a width smaller than a width of each of the driver arms, and each of the detective electrodes extends along a side edge of the center detective arm and each of the detective electrodes has a smaller width than a half width of the center detective arm.

It is further more preferable that the driver electrodes have the same width and the same length, and the detective electrodes have the same width and the same length.

It is moreover preferable that the driver electrodes have a width which is in the range of 50%-70% of a width of each of the driver arms, and a length which is in the range of 40%-70% of a length of each of the driver arms, and each of the first-pared detective electrodes on the right side face of the center detective arm and the second-pared detective electrodes on the left side face of the second detective arm has a total width which is in the range of 30%-50% of a width of the center detective arm, and the detective electrodes have a length in the range of 40%-70% of a length of the center detective electrode.

It is also preferable that first-paired two of the four driver electrodes provided on the front and back main faces of each of side two driver arms of the three driver arms are connected to a first polarity side of an alternating current power source, and second-paired two of the four driver electrodes provided on the right and left side faces of each of side two driver arms of the three driver arms are connected to a second polarity side of the alternating current power source, and first-paired two of the four driver electrodes provided on the front and back- main faces of the center driver arm of the three driver arms are connected to the second polarity side of the alternating current power source, and second-paired two of the four driver electrodes provided on the right and left side faces of the center driver arm of the three driver arms are connected to the first polarity side of the alternating current power source, and two of the four detective electrodes diagonally positioned are connected to the first polarity side of the alternating current power source, and remaining two of the four detective electrodes diagonally positioned are connected to the second polarity side of the alternating current power source.

It is still more preferable that the in-plane vibration of the center driver arm is different in phase by 180 degrees from the in-plane vibration of the two side driver arms.

It is yet more preferable that the vertical-to-plane vibration of the center detective arm is different in phase by 180 degrees from the vertical-to-plane vibration of the two side detective arms.

It is also preferable that four detective electrodes are provided on front and back main faces and right and left side faces of each of the three detective arms, and first-paired driver electrodes are provided on a front face of the center driver electrode and second-pared driver electrodes are provided on a back face of the center driver electrode.

It is further preferable that each of the detective electrodes has a longitudinal center axis which is aligned to a longitudinal center axis of the detective arm, and each of the detective electrodes has a width smaller than a width of each of the detective arms, and each of the driver electrodes extends along a side edge of the center driver arm and each of the driver electrodes has a smaller width than a half width of the center driver arm.

It is further more preferable that the detective electrodes have the same width and the same length, and the driver electrodes have the same width and the same length.

It is further more preferable that the detective electrodes have a width which is in the range of 50%-70% of a width of each of the detective arms, and a length which is in the range of 40%-70% of a length of each of the detective arms, and each of the first-pared driver electrodes on the right side face of the center driver arm and the second-pared driver electrodes on the left side face of the second driver arm has a total width which is in the range of 30%-50% of a width of the center driver arm, and the driver electrodes have a length in the range of 40%-70% of a length of the center driver electrode.

It is also preferable that first-paired two of the four detective electrodes provided on the front and back main faces of each of side two detective arms of the three detective arms are connected to a first polarity side of an alternating current power source, and second-paired two of the four detective electrodes provided on the right and left side faces of each of side two detective arms of the three detective arms are connected to a second polarity side of the alternating current power source, and first-paired two of the four detective electrodes provided on the front and back main faces of the center detective arm of the three detective arms are connected to the second polarity side of the alternating current power source, and second-paired two of the four detective electrodes provided on the right and left side faces of the center detective arm of the three driver arms are connected to the first polarity side of the alternating current power source, and two of the four driver electrodes diagonally positioned are connected to the first polarity side of the alternating current power source, and remaining two of the four driver electrodes diagonally positioned are connected to the second polarity side of the alternating current power source.

It is further preferable that the in-plane vibration of the center driver arm is different in phase by 180 degrees from the in-plane vibration of the two side driver arms.

It is further more preferable that the vertical-to-plane vibration of the center detective arm is different in phase by 180 degrees from the vertical-to-plane vibration of the two side detective arms.

It is also preferable that entire parts of the piezo-electric vibration gyroscope have a uniform thickness.

It is also preferable that a single supporter is mechanically connected to at a gravity center position of the piezo-electric vibration gyroscope.

It is further preferable that the supporter extends from the gravity center position in a vertical direction to the plane of the piezo-electric vibration gyroscope.

It is also preferable that the body has a just rectangle shape having right-angled four corners.

It is also preferable that the body has a generally rectangle shape having cut four corners.

It is also preferable that both a top of a center driver arm in the plural driver arms and a top of a center detective arm in the plural detective arms are cut, so that the center driver arm and the center detective arm are shorter than remaining arms of the plural driver and detective arms.

It is also preferable that each of the plural driver arms and the plural detective arms has a square-shaped section in a plane vertical to the length direction.

The second present invention provides a piezo-electric vibration gyroscope comprising: a body of a rectangle plate shape defined by a first size in a length direction and a second size in a width direction; plural driver arms extending from a first side of the body in the length direction and also extending in the same plane as the body; plural detective arms extending from a second side opposite to the first side of the body in an anti-parallel direction to the length direction and also extending in the same plane as the body; plural driver electrodes being provided on the plural driver arms and being applied with an alternating current voltage for causing the plural driver electrodes to show an in-plane vibration of a driving mode in the width direction included in the plane; plural detecting electrodes on at least one of the plural detective arms for detecting a voltage caused by a vertical-to-plane vibration of a detective mode in a vertical direction to the plane, wherein a single supporter is mechanically connected to at a gravity center position of the piezo-electric vibration gyroscope.

It is preferable that the supporter extends from the gravity center position in a vertical direction to the plane of the piezo-electric vibration gyroscope.

It is also preferable that the first size of the body is equal to or larger than the second size of the body for allowing the vertical-to-plane vibration of the detective mode to propagate from the plural driver arms through the body to the plural detective electrodes and for preventing the in-plane vibration of the driving mode from propagating from the plural driver arms through the body to the plural detective electrodes.

It is further preferable that the body has a higher stiffness in the same direction as the in-plane vibration than other stiffness in other directions.

It is also preferable that the number of the plural driver arms is the same as the number of the plural detective arms.

It is further preferable that the piezo-electric vibration gyroscope is symmetrical both in the length direction and the width direction.

It is further more preferable that a center driver arm in the plural driver arms and a center detective arm in the plural detective arms are aligned on a longitudinal center axis parallel to the length direction.

It is also preferable that the plural driver arms and the plural detective arms have the same length.

It is also preferable that the plural driver arms comprise three driver arms and the plural detective arms comprise three detective arms.

It is further preferable that a center driver arm in the three driver arms and a center detective arm in the three detective arms are aligned on a longitudinal center axis parallel to the length direction.

It is also preferable that the three driver arms and the three detective arms have the same length and have the same width.

It is also preferable that four driver electrodes are provided on front and back main faces and right and left side faces of each of the three driver arms, and first-paired detective electrodes are provided on a front face of the center detective electrode and second-pared detective electrodes are provided on a back face of the center detective electrode.

It is further preferable that each of the driver electrodes has a longitudinal center axis which is aligned to a longitudinal center axis of the driver arm, and each of the driver electrodes has a width smaller than a width of each of the driver arms, and each of the detective electrodes extends along a side edge of the center detective arm and each of the detective electrodes has a smaller width than a half width of the center detective arm.

It is moreover preferable that the driver electrodes have the same width and the same length, and the detective electrodes have the same width and the same length.

It is still further preferable that the driver electrodes have a width which is in the range of 50%-70% of a width of each of the driver arms, and a length which is in the range of 40%-70% of a length of each of the driver arms, and each of the first-pared detective electrodes on the right side face of the center detective arm and the second-pared detective electrodes on the left side face of the second detective arm has a total width which is in the range of 30%-50% of a width of the center detective arm, and the detective electrodes have a length in the range of 40%-70% of a length of the center detective electrode.

It is also preferable that first-paired two of the four driver electrodes provided on the front and back main faces of each of side two driver arms of the three driver arms are connected to a first polarity side of an alternating current power source, and second-paired two of the four driver electrodes provided on the right and left side faces of each of side two driver arms of the three driver arms are connected to a second polarity side of the alternating current power source, and first-paired two of the four driver electrodes provided on the front and back main faces of the center driver arm of the three driver arms are connected to the second polarity side of the alternating current power source, and second-paired two of the four driver electrodes provided on the right and left side faces of the center driver arm of the three driver arms are connected to the first polarity side of the alternating current power source, and two of the four detective electrodes diagonally positioned are connected to the first polarity side of the alternating current power source, and remaining two of the four detective electrodes diagonally positioned are connected to the second polarity side of the alternating current power source.

It is further preferable that the in-plane vibration of the center driver arm is different in phase by 180 degrees from the in-plane vibration of the two side driver arms.

It is further more preferable that the vertical-to-plane vibration of the center detective arm is different in phase by 180 degrees from the vertical-to-plane vibration of the two side detective arms.

It is also preferable that four detective electrodes are provided on front and back main faces and right and left side faces of each of the three detective arms, and first-paired driver electrodes are provided on a front face of the center driver electrode and second-pared driver electrodes are provided on a back face of the center driver electrode.

It is further preferable that each of the detective electrodes has a longitudinal center axis which is aligned to a longitudinal center axis of the detective arm, and each of the detective electrodes has a width smaller than a width of each of the detective arms, and each of the driver electrodes extends along a side edge of the center driver arm and each of the driver electrodes has a smaller width than a half width of the center driver arm.

It is still further preferable that the detective electrodes have the same width and the same length, and the driver electrodes have the same width and the same length.

It is yet further preferable that the detective electrodes have a width which is in the range of 50%-70% of a width of each of the detective arms, and a length which is in the range of 40%-70% of a length of each of the detective arms, and each of the first-pared driver electrodes on the right side face of the center driver arm and the second-pared driver electrodes on the left side face of the second driver arm has a total width which is in the range of 30%-50% of a width of the center driver arm, and the driver electrodes have a length in the range of 40%-70% of a length of the center driver electrode.

It is also preferable that first-paired two of the four detective electrodes provided on the front and back main faces of each of side two detective arms of the three detective arms are connected to a first polarity side of an alternating current power source, and second-paired two of the four detective electrodes provided on the right and left side faces of each of side two detective arms of the three detective arms are connected to a second polarity side of the alternating current power source, and first-paired two of the four detective electrodes provided on the front and back main faces of the center detective arm of the three detective arms are connected to the second polarity side of the alternating current power source, and second-paired two of the four detective electrodes provided on the right and left side faces of the center detective arm of the three driver arms are connected to the first polarity side of the alternating current power source, and two of the four driver electrodes diagonally positioned are connected to the first polarity side of the alternating current power source, and remaining two of the four driver electrodes diagonally positioned are connected to the second polarity side of the alternating current power source.

It is further preferable that the in-plane vibration of the center driver arm is different in phase by 180 degrees from the in-plane vibration of the two side driver arms.

It is further more preferable that the vertical-to-plane vibration of the center detective arm is different in phase by 180 degrees from the vertical-to-plane vibration of the two side detective arms.

It is also preferable that entire parts of the piezo-electric vibration gyroscope have a uniform thickness.

It is also preferable that the body has a just rectangle shape having right-angled four corners.

It is also preferable that the body has a generally rectangle shape having cut four corners.

It is also preferable that both a top of a center driver arm in the plural driver arms and a top of a center detective arm in the plural detective arms are cut, so that the center driver arm and the center detective arm are shorter than remaining arms of the plural driver and detective arms.

It is also preferable that each of the plural driver arms and the plural detective arms has a square-shaped section in a plane vertical to the length direction.

### PREFERRED EMBODIMENT

First Embodiment

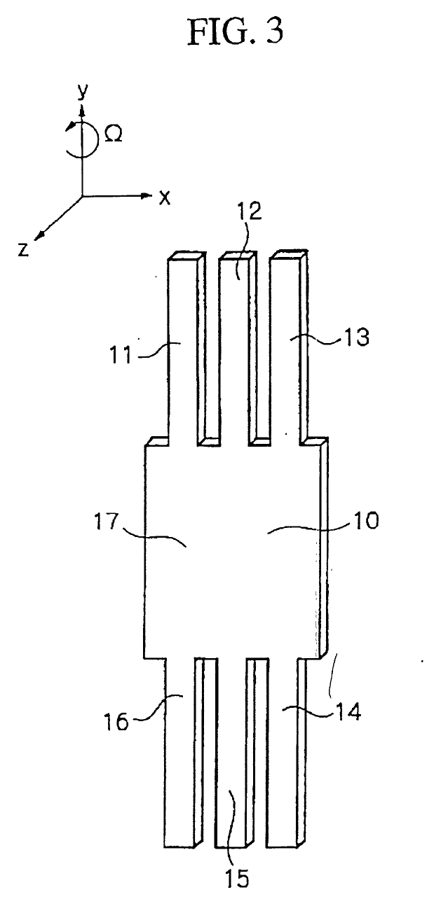

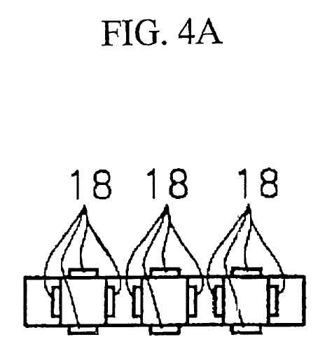

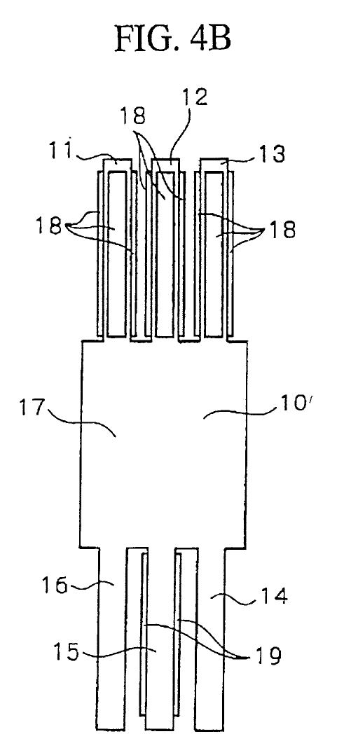

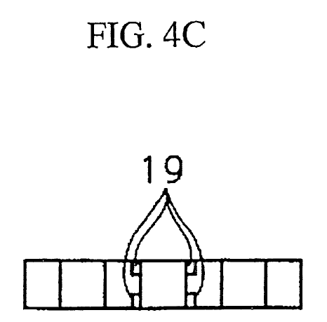

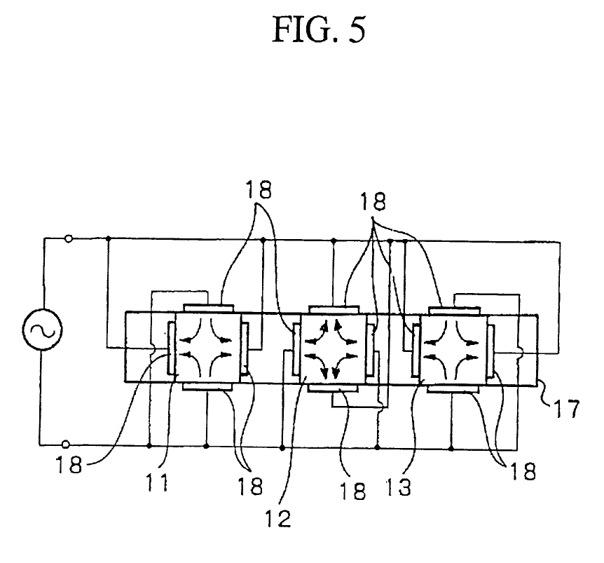

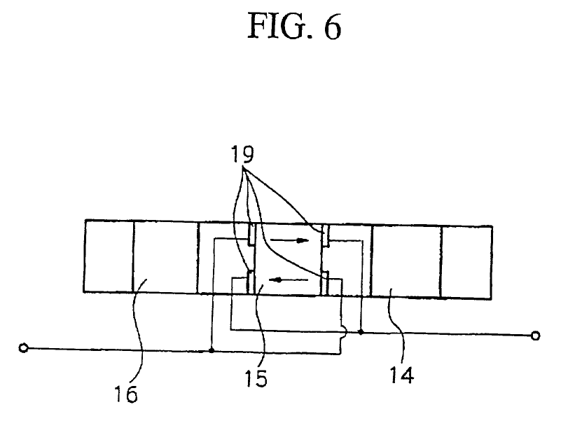

A first embodiment according to the present invention will be described in detail with reference to the drawings. FIG. 3 is a schematic perspective view illustrative of a first novel six-armed piezo-electric vibration gyroscope in a first embodiment in accordance with the present invention. FIG. 4A is a top view illustrative of driver electrodes of the first novel six-armed piezo-electric vibration gyroscope of FIG. 3 in a first embodiment in accordance with the present invention. PIG. 4B is a front view illustrative of a detective electrode and driver electrodes of the first novel six-armed piezo-electric vibration gyroscope of FIG. 3 in a first embodiment in accordance with the present invention. FIG. 4C is a bottom view illustrative of a detective electrode of the first novel six-armed piezo-electric vibration gyroscope of FIG. 3 in a first embodiment in accordance with the present invention. FIG. 5 is a diagram illustrative of connections involving driver electrodes of the first novel six-armed piezo-electric vibration gyroscope of FIG. 3 in a first embodiment in accordance with the present invention. FIG. 6 is a diagram illustrative of connections involving a detective electrode of the first novel six-armed piezo-electric vibration gyroscope of FIG. 3 in a first embodiment in accordance with the present invention.

With reference to FIG. 3, the first novel six-armed piezo-electric vibration gyroscope 10 comprises a rectangle-plate-shaped body 17, first, second, and third driver arms 11, 12, and 13, and first, second, and third driver arms 14, 15, and 16. The rectangle-plate-shaped body 17 has first and second sides opposite to each other and distanced in a longitudinal direction of the rectangle-plate-shaped body 17. The first, second, and third driver arms 11, 12, and 13 extend from the first side of the rectangle-plate-shaped body 17 in the longitudinal direction of the rectangle-plate-shaped body 17, wherein the first, second, and third driver arms 11, 12, and 13 extend in parallel to each other. The first, second, and third driver arms 11, 12, and 13 are provided at a constant pitch, so that a gap between the first and second driver arms 11 and 12 is equal to a gap between the second and third driver arms 12 and 13. The second driver arm 12 is positioned between the first and third driver arms 11 and 13. The first, second and third detective arms 14, 15, and 16 extend from the second side of the rectangle-plate-shaped body 17 in the longitudinal direction of the rectangle-plate-shaped body 17, wherein the first, second, and third detective arms 14, 15, and 16 extend in parallel to each other and in anti-parallel to the first, second, and third driver arms 11, 12, and 13. The first, second, and third detective arms 14, 15, and 16 are provided at a constant pitch, so that a gap between the first and second detective arms 14 and 15 is equal to a gap between the second and third detective arms 15 and 16. The second detective arm 15 is positioned between the first and third detective arms 14 and 16. The first, second, and third driver arms 11, 12, and 13 extend perpendicular to the first side of the rectangle-plate-shaped body 17. The first, second, and third detective arms 14, 15, and 16 extend perpendicular to the second side of the rectangle-plate-shaped body 17. The first, second, and third driver arms 11, 12, and 13 have the same length as each other. The first, second, and third detective arms 14, 15, and 16 also have the same length as each other. The first, second, and third driver arms 11, 12, and 13 are equal in length to the first, second, and third detective arms 14, 15, and 16. The first driver arm 11 and the third detective arm 16 are aligned on a left side line parallel to the longitudinal direction of the rectangle-plate-shaped body 17. The second driver arm 12 and the second detective arm 15 are aligned on a center line parallel to the longitudinal direction of the rectangle-plate-shaped body 17. The third driver arm 13 and the first detective arm 14 are aligned on a right side line parallel to the longitudinal direction of the rectangle-plate-shaped body 17. The first, second, and third driver arms 11, 12, and 13 are equal in pitch to the first, second, and third detective arms 14, 15, and 16. Each of the first, second and third driver arms 11, 12, and 13 has a rod shape having a generally square sectioned shape. Each of the first, second, and third detective arms 14, 15, and 16 also has a rod shape having a generally square sectioned shape. The first, second, and third driver arms 11, 12, and 13 and the first, second, and third detective arms 14, 15, and 16 extend in the same plane as the rectangle-plate-shaped body 17. The six-armed piezo-electric vibration gyroscope comprises a Z-cut Langer site piezo-electric crystal. An X-axis is parallel to the first and second sides of the rectangle-plate-shaped body 17. A Y-axis is parallel to the longitudinal direction of the rectangle-plate-shaped body 17. A Z-axis is vertical to the plane of the six-armed piezo-electric vibration gyroscope 10. Namely, the first, second, and third driver arms 11, 12, and 13 extend in the direction parallel to the Y-axis, whilst the first, second, and third detective arms 14, 15, and 16 extend in the direction anti-parallel to the Y-axis.

With reference to FIGS. 4A, 4B, and 4C, the driver electrodes and the detective electrodes will be described. As described above, each of the first, second, and third driver arms 11, 12, and 13 has a square-rod shape. Each of the first, second, and third detective arms 14, 15, and 16 also has a square-rod shape. Four driver electrodes 18 are provided on four faces of each square-rod of the first, second, and third driver arms 11, 12, and 13. Namely, the four driver electrodes 18 are provided on front and back main faces and right and left side faces of the each square-rod of the first, second and third driver arms 11, 12, and 13. In total, twelve driver electrodes 18 are provided to the first, second, and third driver arms 11, 12, and 13. Each of the driver electrodes 18 has a slender stripe plate shape. Each of the driver electrodes 18 has a slightly smaller width than the each square-rod of the first, second, and third driver arms 11, 12, and 13. Each of the driver electrodes 18 extends in the longitudinal direction of the each square-rod of the first, second, and third driver arms 11, 12, and 13, wherein each of the driver electrodes 18 extends from a position in the vicinity of the base of the each square-rod of the first, second, and third driver arms 11, 12, and 13 to another position in the vicinity of the top of the each square-rod of the first, second, and third driver arms 11, 12, and 13. A longitudinal center axis of each of the driver electrodes 18 is aligned to the longitudinal center axis of the each square-rod of the first, second, and third driver arms 11, 12, and 13, so that the each of the driver electrodes 18 extend on each face of the each square-rod of the first, second, and third driver arms 11, 12, and 13 except on opposite side regions and the top region of the each face of the square-rod. The driver electrodes 18 have the same size and the same shape. Four detective electrodes 19 are provided on right and left side faces of only the second detective arm 15. Namely, the two detective electrodes 19 are provided on the right side face of the second detective arm 15, and the remaining two detective electrodes 19 are provided on the left side face of the second detective arm 15. No detective electrodes are provided on the first and third detective arms 14 and 16. Each of the detective electrodes 19 has a slender stripe plate shape. Each of the detective electrodes 19 has a slightly smaller width than a half width of the second detective arm 15. A first pair of the detective electrodes 19 extends in the longitudinal direction of the left side face of the second detective arm 16, wherein the detective electrodes 19 extend in the longitudinal direction of the second detective arm 16 and on the left side face of the second detective electrode 16 but along the opposite sides of the second detective electrode 16, so that the paired detective electrodes 19 are distanced from each other by the center region of the left side face of the second detective arm 16. A second pair of the detective electrodes 19 extends in the longitudinal direction of the right side face of the second detective arm 16, wherein the detective electrodes 19 extend in the longitudinal direction of the second detective arm 16 and on the right side face of the second detective electrode 16 but along the opposite sides of the second detective electrode 16, so that the paired detective electrodes 19 are distanced from each other by the center region of the left side face of the second detective arm 16. The four detective electrodes 19 thus extend along the four corner-sides of the square-rod shape detective electrodes 19. The four detective electrodes 19 extend from a position in the vicinity of the base of the second detective arm 16 to another position in the vicinity of the top of the second detective arm 16.

With reference to FIG. 5, connections of the driver electrodes 18 will subsequently be described. The driver electrodes 18 are connected to an alternating current power source. The driver electrodes 18 placed on the front and back main faces of the first driver arm 11 are connected to a first polarity side of the alternating current power source. The driver electrodes 18 placed on the left and right side faces of the first driver arm 11 are connected to a second polarity side of the alternating current power source. The driver electrodes 18 placed on the front and back main faces of the second driver arm 12 are connected to the second polarity side of the alternating current power source. The driver electrodes 18 placed on the left and right side faces of the second driver arm 12 are connected to the first polarity side of the alternating current power source. The driver electrodes 18 placed on the front and back main faces of the third driver arm 13 are connected to the first polarity side of the alternating current power source. The driver electrodes 18 placed on the left and right side faces of the third driver arm 13 are connected to the second polarity side of the alternating current power source. The driver electrodes 18 placed on the second driver arm 12 are opposite in polarity to the driver electrodes 18 placed on the first and third driver arm 11 and 13.

The detective electrodes 19 are also connected to the alternating current power source. First two of the detective electrodes 19 diagonally positioned are connected to a first polarity side of the alternating current power source. Second two of the detective electrodes 19 diagonally positioned are connected to a second polarity side of the alternating current power source. The two detective electrodes 19 provided on the same side face of the second detective electrode are connected to opposite polarity sides of the alternating current power source.

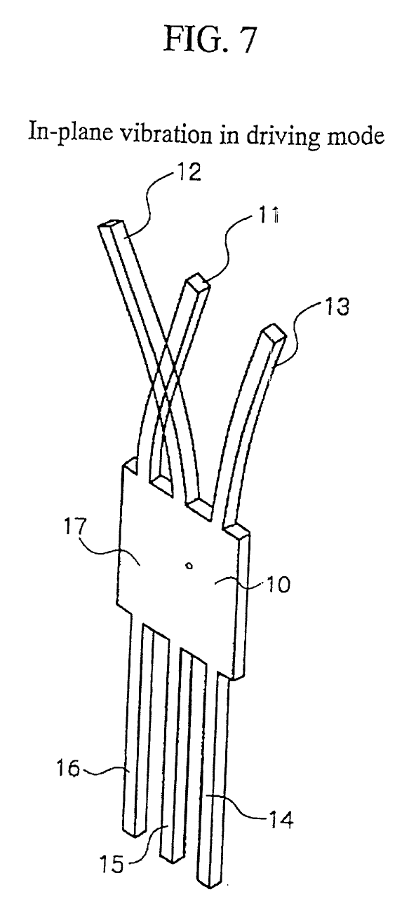

Operations of detecting the angular velocity of the rotating object by the first novel six-armed piezo-electric vibration gyroscope 10 will subsequently be described. An alternating current voltage is applied to the driver electrodes 18 thereby exciting electric fields represented by arrow marks in FIG. 5 in each of the first, second, and third driver arms 11, 12, and 13 which comprise piezo-electric material. This excitation of the electric fields in the first, second, and third driver arms 11, 12, and 13 causes mechanical pressures applied to the first, second, and third driver arms 11, 12, and 13. This mechanical pressures applied to the first, second, and third driver arms 11, 12, and 13 causes right and left displacements in the main plane of the first, second, and third driver arms 11, 12, and 13. The first and third driver arms 11 and 13 are identical with each other in direction of the excited electric field, for which reason the first and third driver arms 11 and 13 are identical with each other in direction of the displacement. As a result, the first and third driver arms 11 and 13 are identical with each other in phase of the in-plane vibration. The first and third driver arms 11 and 13 are, however, opposite to the second driver arm 12 in direction of the excited electric field, for which reason the first and third driver arms 11 and 13 are, however, opposite to the second driver arm 12 in direction of the displacement. As a result, the first and third driver arms 11 and 13 are, however, opposite to the second driver arm 12 in phase of the in-plane vibration. FIG. 7 is a schematic perspective view illustrative of a first novel six-armed piezo-electric vibration gyroscope showing the in-plane vibrations of the three driver arms in a first embodiment in accordance with the present invention. The second driver arm 12 shows the in-plane vibration which is different in phase by 180 degrees from the in-plane vibrations of the first and third driver arms 11 and 13, wherein the second driver arm 12 is opposite in direction of the displacement to the first and third driver arms 11 and 13. In accordance with the illustration, the displacements of the first, second, and third driver arms 11, 12, and 13 are emphasized so that the second driver arm 12 is close to the first driver arm 11. Notwithstanding, actually, however, the displacements are extremely small and it is never caused that the second driver arm 12 close to the first and third driver arms 11 and 13.

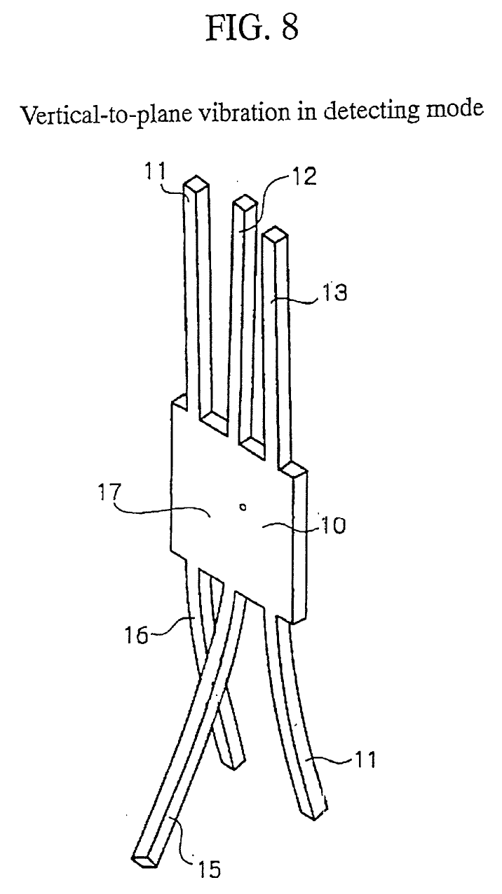

If the above six-armed piezo-electric vibration gyroscope 10 is placed on a rotating object which rotates around the Y-axis in FIG. 3 at an angular velocity Ω, the Coriolis force is applied to the first, second and third driver arms 11, 12, and 13 in the direction vertical to the main face of the six-armed piezo-electric vibration gyroscope 10. FIG. 8 is a schematic perspective view illustrative of a first novel six-armed piezo-electric vibration gyroscope showing the vertical-to-plane vibrations of the center detective arm in a first embodiment in accordance with the present invention. The Coriolis force as applied to the first, second, and third driver arms 11, 12, and 13 causes that the first, second, and third driver arms 11, 12, and 13 show the vertical-to-plane vibrations, wherein the first and third driver arms 11 and 13 are identical with each other in phase of the vertical-to-plane vibrations, whilst the second driver arm 12 is different from the first and third driver arms 11 and 13 in phase of the vertical-to-plane vibrations by 180 degrees. Those vertical-to-plane vibrations of the first, second, and third driver arms 11, 12, and 13 propagate through the body 17 to the first, second, and third detective arms 14, 15, and 16 in the opposite side. As a result, it is cased that the first, second, and third detective arms 14, 15, and 16 the vertical-to-plane vibrations in the direction vertical to the main face of the six-armed piezo-electric vibration gyroscope 10, wherein the first and third detective arms 14 and 16 are identical with each other in phase of the vertical-to-plane vibrations, whilst the second detective arm 15 is different from the first and third detective arms 14 and 16 in phase of the vertical-to-plane vibrations by 180 degrees. The above in-plane vibration is the driving mode of the six-armed piezo-electric vibration gyroscope 10, whilst this vertical-to-plane vibration is the detecting mode of the six-armed piezo-electric vibration gyroscope 10. The displacements of the first, second, and third detective arms 14, 15, and 16 in the vertical-to-plane vibrations is larger in a few times than the displacements of the first and third driver arms 11, 12, and 13 in the vertical-to-plane vibrations. It is, however, important for the present invention that the body 17 has such a rectangle plate shape that a length size in a length direction is equal to or larger than a width size in a width direction. The length size is the size of the body 17 in the length direction, which is parallel to the longitudinal direction of the first, second third driver arms 11, 12, and 13, and the first, second, and third detective arms 14, 15, and 16. The width size is the size of the body 17 in the width direction, which is parallel to the first and second opposite sides of the body 17 and also which is perpendicular to the longitudinal direction of the first, second third driver arms 11, 12, and 13, and the first, second, and third detective arms 14, 15, and 16. The body 17 having the rectangle plate shape has a high in-plane stiffness in the plane direction. The above specific size and the high in-plane stiffness of the body 17 causes that the in-plane vibrations of the first, second, and third driver arms 11, 12, and 13 are almost not propagated to the opposite side first, second, and third detective arms 14, 15, and 16. The body 17 is intentionally designed to have the length size equal to or larger than the width size in order to prevent the propagation of the in-plane vibrations from the first, second third driver arms 11, 12, and 13 toward the first, second, and third detective arms 14, 15, and 16. Accordingly, almost no in-plane vibration is excited to the first, second, and third detective arms 14, 15, and 16. The second detective arm 15 shows the vertical-to-plane vibration. The displacement of the second detective arm 15 in the vertical-to-plane vibration causes electric fields, which are anti-parallel to each other and also are represented by the arrow marks in FIG. 6. The electric fields caused in accordance with the displacement of the second detective arm 15 in the vertical-to-plane vibration cause potential variations of the detective electrodes 19 on the opposite side faces of the detective arm 15, wherein the potential variations accord to the displacement of the second detective arm 15 in the vertical-to-plane vibration. An amplitude of the potential is measured to measure an angular velocity Ω of the rotating object around the Y-axis.

In the meantime, FIGS. 7 and 8 illustrate the in-plane vibration mode and the vertical-to-plane vibration mode of the six-armed piezo-electric vibration gyroscope 10, which have been analyzed by the finite element method. It was, however, confirmed that distributions of the actual in-plane vibration and the actual vertical-to-plane vibration, which have been actually measured by a laser Doppler vibro-meter well correspond to the above analyzed in-plane and vertical-to-plane vibration modes.

The six-armed piezo-electric vibration gyroscope 10 was prepared as follows. A plate of the six-armed piezo-electric vibration gyroscope 10 was cut from the Z-cut Langer site plate by a wire-cutting method. An evaporation and a photo-resist method was carried out to selectively form Au/Cr evaporation electrodes which serve as the driver electrodes 18 and the detective electrodes 19.

In order to suppress any noise vibration which is different from the above in-plane vibration in the driver mode and the above vertical-to-plane vibration in the detective mode, it is preferable that the six-armed piezo-electric vibration gyroscope 10 is symmetrically designed with reference to both the top and bottom directions and also the right and left directions and also that the first, second, and third driver arms 11, 12, and 13, the first, second, and third detective arms 14, 15, and 16 and the body 17 have the same length. If the six-armed piezo-electric vibration gyroscope 10 is largely different in shape from the above symmetrical and uniform-length shape, then undesirable vibration having a different frequency from a resonant frequency of the in-plane vibration and also from a resonant frequency of the vertical-to-plane vibration, whereby a spurious response appears. The above symmetrical and uniform-length shape of the six-armed piezo-electric vibration gyroscope 10 allows the six-armed piezo-electric vibration gyroscope 10 to have spurious response free desirable frequency responsibility and high speed responsibility. It is, for example, possible that the first, second, and third driver arms 11, 12, and 13, the first, second, and third detective arms 14, 15, and 16 and the body 17 have the same thickness of 0.42 mm. The first, second, and third driver arms 11, 12, and 13, and the first, second, and third detective arms 14, 15, and 16 have the same width of 0.4 mm and the same length of 6.0 mm. The body 17 has a length in the range of 4.0 mm to 6.0 mm and a width of 4 mm.

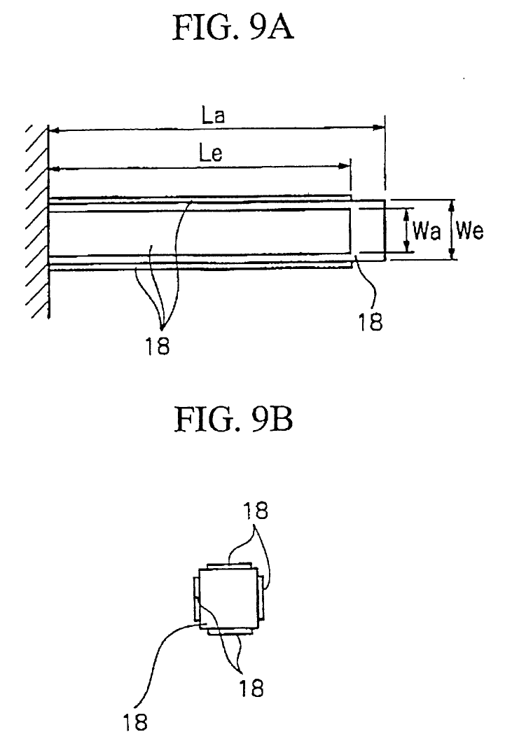

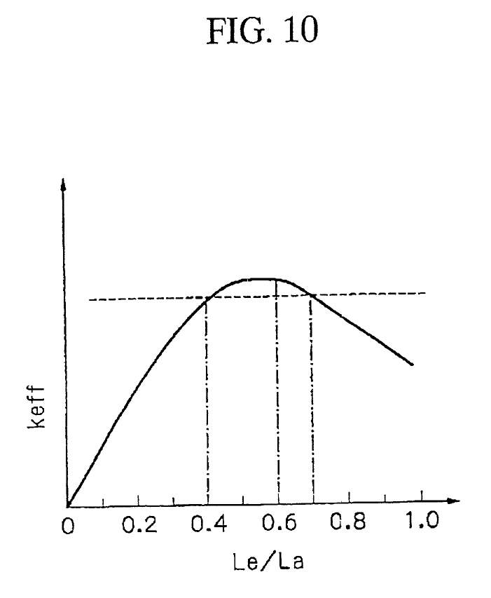

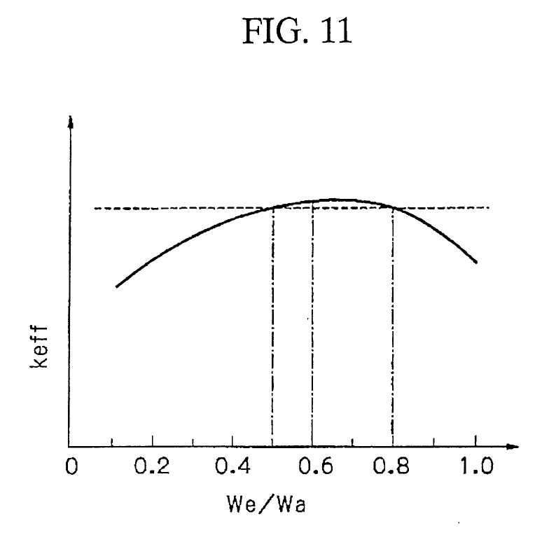

In order to excite the in-plane vibration of the first, second, and third driver arms 11, 12, and 13 at a possible high frequency upon voltage application to the driver electrodes 18, it is preferable that the driver electrodes 18 has such a size as possible increase the effective electromechanical coupling coefficient. A inter-relationship between the effective electromechanical coupling coefficient and the size of the driver electrode 18 will be described. The body 17 is sufficiently larger in stiffness than the first, second, and third driver arms 11, 12, and 13. For this reason, each of the first, second, and third driver arms 11, 12, and 13 may be considered to be a one-side supported beam. FIG. 9A is a side view illustrative of a driver arm as considered to be a one-side supported beam of the six-armed piezo-electric vibration gyroscope in a first embodiment in accordance with the present invention. FIG. 9B is a top view illustrative of a top of the driver arm as considered to be a one-side supported beam in FIG. 9A. The inter-relationship between the effective electromechanical coupling coefficient and the size of the driver electrode 18 was investigated as follows. It is assumed that the driver electrode 18 has a width “We” and a length “Le”, and the second driver arm 12 has a width “Wa” and a length “La”. A ratio of “We”/“Wa” is kept constant at 0.7, whilst a ratio of “Le”/“La” is changed from 0 to 1. At this time, variations in the effective electromechanical coupling coefficient as a relative value versus the ratio “Le”/“La” was investigated. FIG. 10 is a diagram illustrative of variations in the effective electromechanical coupling coefficient as a relative value versus the ratio “Le”/“La”, provided that the ratio “We”/“Wa” is kept constant at 0.7. The effective electromechanical coupling coefficient is high in the range of the ratio “Le”/“La” from 0.4 to 0.6. The ratio “We”/“Wa” is changed from 0 to 1, whilst a ratio of “Le”/“La” is kept constant at 0.6. At this time, variations in the effective electromechanical coupling coefficient as a relative value versus the ratio “We”/“Wa” was investigated. FIG. 11 is a diagram illustrative of variations in the effective electromechanical coupling coefficient as a relative value versus the ratio “We”/“Wa”, provided that the ratio “Le”/“La” is kept constant at 0.6. The effective electromechanical coupling coefficient is high in the range of the ratio “We”/“Wa” from 0.5 to 0.8. Consequently, in order to obtain possible high effective electromechanical coupling coefficient, it is preferable that the driver electrodes 18 are in the range of length from 40% to 70% of the first, second, and third driver arms 11, 12, and 13, and that the driver electrodes 18 are in the range of width from 50% to 80% of the first, second, and third driver arms 11, 12, and 13.

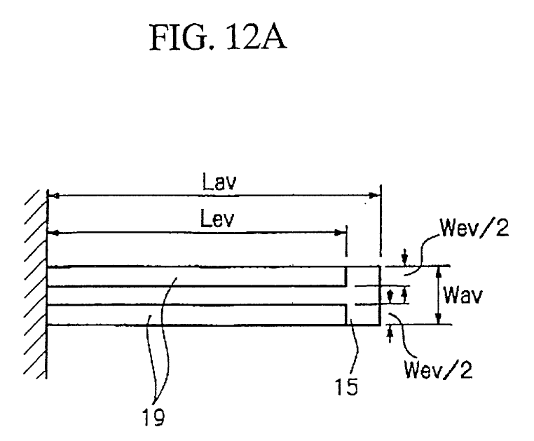

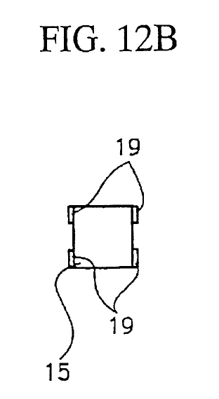

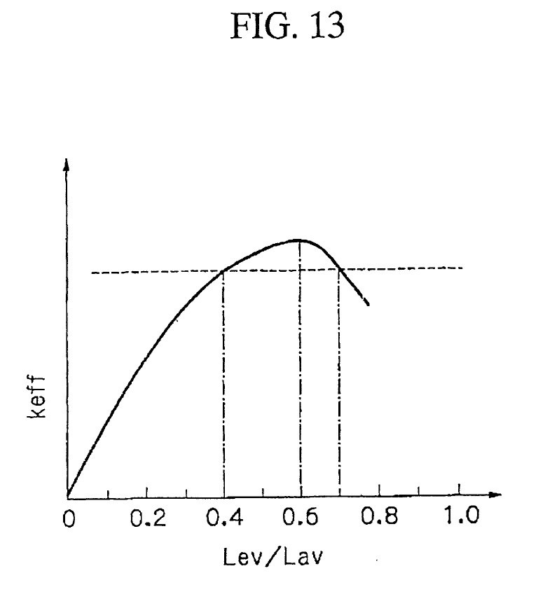

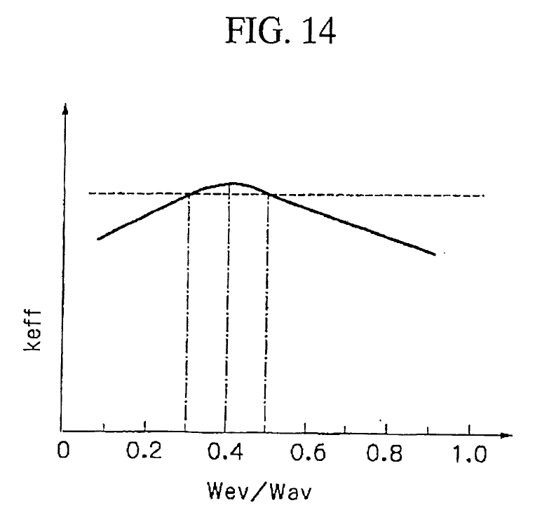

In order to excite the in-plane vibration of the second detective arm 15 at a possible high frequency upon voltage application to the detective electrodes 19, it is preferable that the detective electrodes 19 has such a size as possible increase the effective electromechanical coupling coefficient. A inter-relationship between the effective electromechanical coupling coefficient and the size of the detective electrode 19 will be described. The body 17 is sufficiently larger in stiffness than the second detective arm 15. For this reason, each of the second detective arm 15 may be considered to be a one-side supported beam. FIG. 12A is a side view illustrative of a detective arm as considered to be a one-side supported beam of the six-armed piezo-electric vibration gyroscope in a first embodiment in accordance with the present invention. FIG. 12B is a top view illustrative of a top of the detective arm as considered to be a one-side supported beam in FIG. 12A. The inter-relationship between the effective electromechanical coupling coefficient and the size of the detective electrode 19 was investigated as follows. It is assumed that the detective electrode 19 has a width “Wev” and a length “Lev”, and the second detective arm 15 has a width “Wav” and a length “Lav”. A ratio of “Wev”/“Wav” is kept constant at 0.5, whilst a ratio of “Lev”/“Lav” is changed from 0 to 1. At this time, variations in the effective electromechanical coupling coefficient as a relative value versus the ratio “Lev”/“Lav” was investigated. FIG. 13 is a diagram illustrative of variations in the effective electromechanical coupling coefficient as a relative value versus the ratio “Lev”/“Lav”, provided that the ratio “Wev”/“Wav” is kept constant at 0.5. The effective electromechanical coupling coefficient is high in the range of the ratio “Lev”/“Lav” from 0.4 to 0.7. The ratio “Wev”/“Wav” is changed from 0 to 1, whilst the ratio “Lev”/“Lav” is kept constant at 0.6. At this time, variations in the effective electromechanical coupling coefficient as a relative value versus the ratio “Wev”/“Wav” was investigated. FIG. 14 is a diagram illustrative of variations in the effective electromechanical coupling coefficient as a relative value versus the ratio “Wev”/“Wav”, provided that the ratio “Lev”/“Lav” is kept constant at 0.6. The effective electromechanical coupling coefficient is high in the range of the ratio “Wev”/“Wav” from 0.3 to 0.5. Consequently, in order to obtain possible high effective electromechanical coupling coefficient, it is preferable that the detective electrodes 19 are in the range of length from 40% to 70% of the second detective arm 15, and that the detective electrodes 19 are in the range of width from 30% to 50% of the second detective arm 15.

If a difference between the resonant frequency of the in-plane vibration in the driver mode and the resonant frequency of the vertical-to-plane vibration in the detective mode is extremely small, then the sensitivity of the six-armed piezo-electric vibration gyroscope 10 is high but influences of noises caused by transitional variations in angular velocity due to external vibration is relatively large. In order to allow the six-armed piezo-electric vibration gyroscope 10 to have good frequency responsibility and high sensitivity, it is effective to do the de-tuning so as to increase the difference between the resonant frequency of the in-plane vibration in the driver mode and the resonant frequency of the vertical-to-plane vibration in the detective mode. It is assumed that the six-armed piezo-electric vibration gyroscope 10 is mounted on an automobile. In this case, it is preferable that the difference between the resonant frequency of the in-plane vibration in the driver mode and the resonant frequency of the vertical-to-plane vibration in the detective mode is about 100 Hz. In this example, this difference is set at 96 Hz. One method of how to tune the difference between the resonant frequency of the in-plane vibration in the driver mode and the resonant frequency of the vertical-to-plane vibration in the detective mode will be investigated. Four corners of the rectangle-shaped body 17 are cut by a laser. If the four corners of the body 17 are cut, then both the resonant frequency of the in-plane vibration in the driver mode and the resonant frequency of the vertical-to-plane vibration in the detective mode are decreased, wherein the amount of the decrease of the resonant frequency of the in-plane vibration in the driver mode is larger than the amount of the decrease of the resonant frequency of the vertical-to-plane vibration in the detective mode. Namely, the difference between the resonant frequency of the in-plane vibration in the driver mode and the resonant frequency of the vertical-to-plane vibration in the detective mode is tunable by cutting the four corners of the body 17. Another method of how to tune the difference between the resonant frequency of the in-plane vibration in the driver mode and the resonant frequency of the vertical-to-plane vibration in the detective mode will be investigated. The top of the second driver arm 12 positioned at the center and the top of the second detective arm 15 positioned at the center are cut by a laser. If the top of the second driver arm 12 positioned at the center and the top of the second detective arm 15 positioned at the center are cut, then both the resonant frequency of the in-plane vibration in the driver mode and the resonant frequency of the vertical-to-plane vibration in the detective mode are increased, wherein the amount of the increase of the resonant frequency of the vertical-to-plane vibration in the detective mode is larger than the amount of the increase of the resonant frequency of the in-plane vibration in the driver mode. Namely, the difference between the resonant frequency of the in-plane vibration in the driver mode and the resonant frequency of the vertical-to-plane vibration in the detective mode is tunable by cutting the top of the second driver arm 12 positioned at the center and the top of the second detective arm 15 positioned at the center.

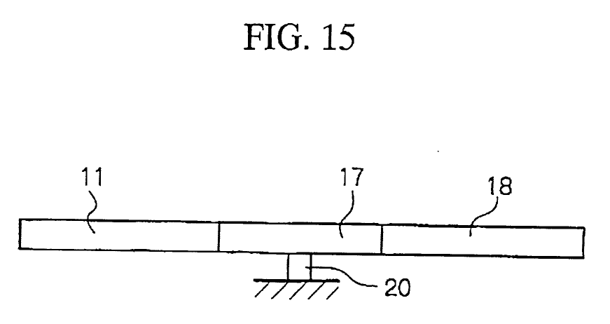

The six-armed piezo-electric vibration gyroscope 10 is symmetrical in shape with reference to both the top and bottom directions and the right and left directions. For this reason, a vibration displacement at the gravity center of the six-armed piezo-electric vibration gyroscope 10 in vibration is extremely small, for example, not more than 1/10000 of the maximum vibration displacement of the first, second, and third driver arms 11, 12, and 13, and the first, second, and third detective arms 14, 15, and 16. This means it possible to realize a highly stable support of the six-armed piezo-electric vibration gyroscope 10 at its gravity center. FIG. 15 is a schematic side view illustrative of a six-armed piezo-electric vibration gyroscope supported by a supporter at a position of gravity center in a first embodiment in accordance with the present invention. The six-armed piezo-electric vibration gyroscope 10 is supported by a supporter 20 at a position of gravity center. The supporter 20 may comprise a quartz glass. The supporter 20 has a diameter of 1 mm and a height of 1 mm. If the six-armed piezo-electric vibration gyroscope 10 is supported by the supporter at its gravity center, then the mechanical quality factor of the six-armed piezo-electric vibration gyroscope 10 is reduced but only about 30%. Variations, by the support, in both the resonant frequency of the in-plane vibration in the driver mode and the resonant frequency of the vertical-to-plane vibration in the detective mode are only within 10 Hz. The six-armed piezo-electric vibration gyroscope 10 was supported by the supporter 20 at its gravity center for detecting the angular velocity. A detective sensitivity was high at 0.8 mV/(deg/s).

In accordance with the six-armed piezo-electric vibration gyroscope 10, as described above, the first and third driver arms 11 and 13 show the in-plane vibration of the driver mode in the same phase and the second driver arm 12 shows the in-plane vibration of the driver mode in the opposite phase to the first and third driver arms 11 and 13. The Coriolis force is effected to the in-plane vibrations of the first, second, and third driver arms 11, 12, and 13, thereby exciting the vertical-to-plane vibration on the first, second, and third driver arms 11, 12, and 13. This vertical-to-plane vibration of the first, second, and third driver arms 11, 12, and 13 is then propagated through the body 17 to the first, second, and third detective arms 14, 15, and 16. The in-plane vibration of the first, second, and third driver arms 11, 12, and 13 is almost not propagated through the body 17 to the first, second, and third detective arms 14, 15, and 16, whereby the first, second, and third detective arms 14, 15, and 16 show the vertical-to-plane vibration as the detective mode without the in-plane vibration as the driver mode. Almost no mechanical coupling between the driver mode in-plane vibration and the detective mode vertical-to-plane vibration appears on the first, second, and third detective arms 14, 15, and 16. The detective mode vertical-to-plane vibration is detectable at high sensitivity and a high signal-to-noise ratio by the first, second, and third detective arms 14, 15, and 16.

The first, second, and third driver arms 11, 12, and 13 are distanced by the body 17 from the first, second, and third detective arms 14, 15, and 16, for which reason an electrostatic coupling is unlikely to appear, and this allows a highly sensitive detection at a high signal-to-noise ratio.

The vibration displacements of the first, second, and third detective arms 14, 15, and 16 are larger by a few times than the vibration displacements of the first, second, and third driver arms 11, 12, and 13.

In the above described embodiment, the piezo-electric material comprises the Z-cut Langer site. It is, however, possible that the piezo-electric material comprises the Z-cut crystal.

In the above described embodiment, the detective electrodes 19 are provided on the second detective arm 15 positioned at center between the first and third detective arms 14 and 16 for detecting the detective mode vertical-to-plane vibration. It is, however, possible that the detective electrodes 19 are provided on the first and third detective arms 14 and 16 for detecting the detective mode vertical-to-plane vibration. It is also possible that the detective electrodes 19 are provided on the first, second, and third detective arms 14, 15, and 16 for detecting the detective mode vertical-to-plane vibration.

In the above described embodiment, a first set of the first, second and third driver arms 11, 12, and 13 and a second set of the first, second, and third detective arms 14, 15, and 16 are positioned at opposite sides of the body 10 and the first, second, and third driver arms 11, 12, and 13 extend in the anti-parallel directions to the first, second, and third detective arms 14, 15, and 16. The above six-armed shape may be changeable provided that the driver arms and the detective arms are separated by the body from each other, and the in-plane vibration parallel to the main face of the body of the piezo-electric vibration gyroscope is excited on the driver arms, and propagation of the in-plane vibration of the driver arms to the detective arms is suppressed.

As described above, the piezo-electric vibration gyroscope in accordance with the present invention is capable of detecting the angular velocity at a high signal-to-noise ratio. The piezo-electric vibration gyroscope is superior in resolving power, for example, enable to detect a smaller angular velocity than the spin of the earth. Further, the piezo-electric vibration gyroscope is supported by the supporter at its gravity center. Further, the shapes of the driver electrodes and the detective electrodes are optimized so as to obtain the large effective electromechanical coupling coefficient between the driver arms and the detective arms. The displacement of the detective arms in the vibrations is larger by a few times than the displacement of the driver arms in the vibrations, for which reason the piezo-electric vibration gyroscope is capable of detecting the angular velocity at high sensitivity.

Second Embodiment

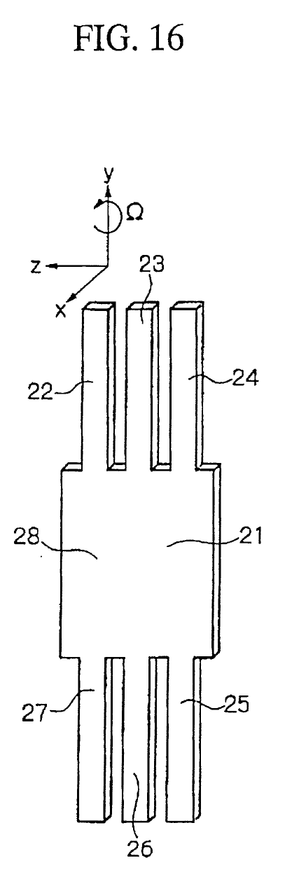

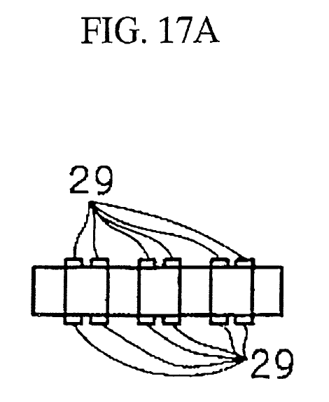

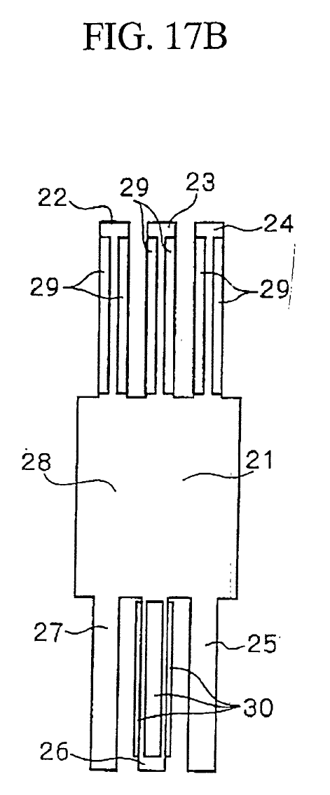

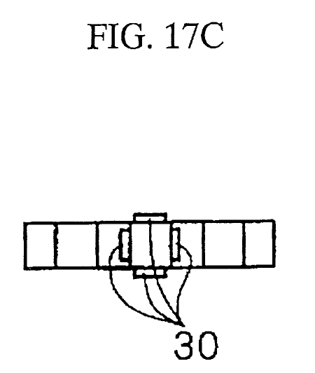

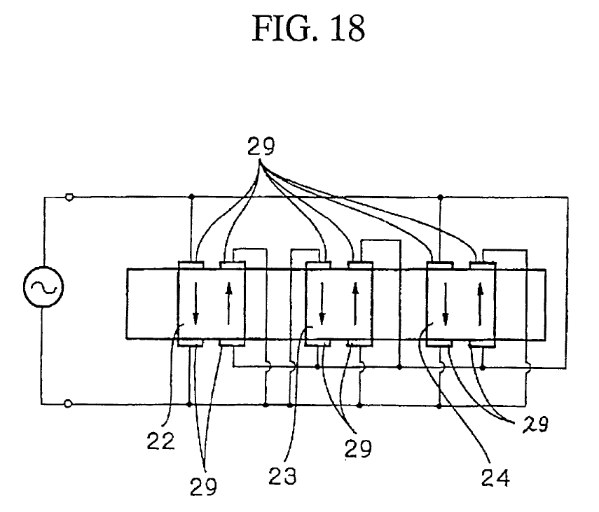

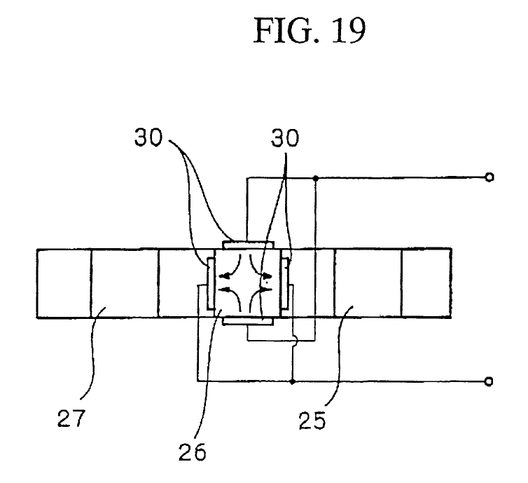

A second embodiment according to the present invention will be described in detail with reference to the drawings. FIG. 16 is a schematic perspective view illustrative of a second novel six-armed piezo-electric vibration gyroscope in a second embodiment in accordance with the present invention. PIG. 17A is a top view illustrative of driver electrodes of the second novel six-armed piezo-electric vibration gyroscope of FIG. 16 in a second embodiment in accordance with the present invention. FIG. 17B is a front view illustrative of a detective electrode and driver electrodes of the second novel six-armed piezo-electric vibration gyroscope of FIG. 16 in a second embodiment in accordance with the present invention. FIG. 17C is a bottom view illustrative of a detective electrode of the second novel six-armed piezo-electric vibration gyroscope of FIG. 16 in a second embodiment in accordance with the present invention. FIG. 18 is a diagram illustrative of connections involving driver electrodes of the second novel six-armed piezo-electric vibration gyroscope of FIG. 16 in a second embodiment in accordance with the present invention. FIG. 19 is a diagram illustrative of connections involving a detective electrode of the second novel six-armed piezo-electric vibration gyroscope of FIG. 16 in a second embodiment in accordance with the present invention.

With reference to FIG. 16, the second novel six-armed piezo-electric vibration gyroscope 21 comprises a rectangle-plate-shaped body 28, first, second, and third driver arms 22, 23, and 24, and first, second, and third driver arms 25, 26, and 27. The rectangle-plate-shaped body 28 has first and second sides opposite to each other and distanced in a longitudinal direction of the rectangle-plate-shaped body 28. The first, second, and third driver arms 22, 23, and 24 extend from the first side of the rectangle-plate-shaped body 28 in the longitudinal direction of the rectangle-plate-shaped body 28, wherein the first, second, and third driver arms 22, 23, and 24 extend in parallel to each other. The first, second, and third driver arms 22, 23, and 24 are provided at a constant pitch, so that a gap between the first and second driver arms 22 and 23 is equal to a gap between the second and third driver arms 23 and 24. The second driver arm 23 is positioned between the first and third driver arms 22 and 24. The first, second, and third detective arms 25, 26, and 27 extend from the second side of the rectangle-plate-shaped body 28 in the longitudinal direction of the rectangle-plate-shaped body 28, wherein the first, second, and third detective arms 25, 26, and 27 extend in parallel to each other and in anti-parallel to the first, second, and third driver arms 22, 23, and 24. The first, second, and third detective arms 25, 26, and 27 are provided at a constant pitch, so that a gap between the first and second detective arms 25 and 26 is equal to a gap between the second and third detective arms 26 and 27. The second detective arm 26 is positioned between the first and third detective arms 25 and 27. The first, second, and third driver arms 22, 23, and 24 extend perpendicular to the first side of the rectangle-plate-shaped body 28. The first, second, and third detective arms 25, 26, and 27 extend perpendicular to the second side of the rectangle-plate-shaped body 28. The first, second, and third driver arms 22, 23, and 24 have the same length as each other. The first, second, and third detective arms 25, 26, and 27 also have the same length as each other. The first, second, and third driver arms 22, 23, and 24 are equal in length to the first, second, and third detective arms 25, 26, and 27. The first driver arm 22 and the third detective arm 27 are aligned on a left side line parallel to the longitudinal direction of the rectangle-plate-shaped body 28. The second driver arm 23 and the second detective arm 26 are aligned on a center line parallel to the longitudinal direction of the rectangle-plate-shaped body 28. The third driver arm 24 and the first detective arms 25 are aligned on a right side line parallel to the longitudinal direction of the rectangle-plate-shaped body 28. The first, second, and third driver arms 22, 23, and 24 are equal in pitch to the first, second, and third detective arms 25, 26, and 27. Each of the first, second and third driver arms 22, 23, and 24 has a rod shape having a generally square sectioned shape. Each of the first, second, and third detective arms 25, 26, and 27 also has a rod shape having a generally square sectioned shape. The first, second, and third driver arms 22, 23, and 24 and the first, second, and third detective arms 25, 26, and 27 extend in the same plane as the rectangle-plate-shaped body 28. The six-armed piezo-electric vibration gyroscope comprises an X-cut Langer site piezo-electric crystal. An X-axis is parallel to the first and second sides of the rectangle-plate-shaped body 28. A Y-axis is parallel to the longitudinal direction of the rectangle-plate-shaped body 28. A Z-axis is vertical to the plane of the six-armed piezo-electric vibration gyroscope 21. Namely, the first, second, and third driver arms 22, 23, and 24 extend in the direction parallel to the Y-axis, whilst the first, second, and third detective arms 25, 26, and 27 extend in the direction anti-parallel to the Y-axis.

With reference to FIGS. 17A, 17B, and 17C, the driver electrodes and the detective electrodes will be described. As described above, each of the first, second, and third driver arms 22, 23, and 24 has a square-rod shape. Each of the first, second, and third detective arms 25, 26, and 27 also has a square-rod shape. Four driver electrodes 29 are provided on front and back main faces of each square-rod of the first, second, and third driver arms 22, 23, and 24. Namely, the two driver electrodes 29 are provided on front main face of the each square-rod of the first, second, and third driver arms 22, 23, and 24, whilst the remaining two driver electrodes 29 are provided on back main face of the each square-rod of the first, second, and third driver arms 22, 23, and 24. In total, twelve driver electrodes 29 are provided to the first, second, and third driver arms 22, 23, and 24. Each of the driver electrodes 29 has a slender stripe plate shape. Each of the driver electrodes 29 has a slightly smaller width than a half width of the each square-rod of the first, second, and third driver arms 22, 23, and 24. Each of the driver electrodes 29 extends in the longitudinal direction of the each square-rod of the first, second, and third driver arms 22, 23, and 24, wherein each of the driver electrodes 29 extends from a position in the vicinity of the base of the each square-rod of the first, second, and third driver arms 22, 23, and 24 to another position in the vicinity of the top of the each square-rod of the first, second, and third driver arms 22, 23, and 24. First-paired two driver electrodes 29 on the front face extend along the opposite sides of the each square-rod of the first, second, and third driver arms 22, 23, and 24, so that the first-paired two driver electrodes 29 are separated by a center region of the front face. First-paired two driver electrodes 29 on the front face extend along the opposite sides of the each square-rod of the first, second, and third driver arms 22, 23, and 24, so that the first-paired two driver electrodes 29 are separated by a center region of the front face. The driver electrodes 29 have the same size and the same shape. Four detective electrodes 30 are provided on the front and back main faces and the right and left side faces of only the second detective arm 26. No detective electrodes are provided on the first and third detective arms 25 and 27. Each of the detective electrodes 30 has a slender stripe plate shape. Each of the detective electrodes 30 has a slightly smaller width than a full width of the second detective arm 26. A longitudinal center of each of the detective electrodes 30 is aligned to a longitudinal center of each of the front and back main faces and the right and left side faces of only the second detective arm 26. The four detective electrodes 30 extend from a position in the vicinity of the base of the second detective arm 27 to another position in the vicinity of the top of the second detective arm 27.

With reference to PIG. 18, connections of the driver electrodes 29 will subsequently be described. The driver electrodes 29 are connected to an alternating current power source. Left one of the first-pared driver electrodes 29 placed on the front main face of the first driver arm 22 is connected to a first polarity side of the alternating current power source. Right one of the first-pared driver electrodes 29 placed on the front main face of the first driver arm 22 is connected to a second polarity side of the alternating current power source. Left one of the second-pared driver electrodes 29 placed on the back main face of the first driver arm 22 is connected to the second polarity side of the alternating current power source. Right one of the second-pared driver electrodes 29 placed on the back main face of the first driver arm 22 is connected to the first polarity side of the alternating current power source. Left one of the first-pared driver electrodes 29 placed on the front main face of the second driver arm 23 is connected to the second polarity side of the alternating current power source. Right one of the first-pared driver electrodes 29 placed on the front main face of the second driver arm 23 is connected to the first polarity side of the alternating current power source. Left one of the second-pared driver electrodes 29 placed on the back main face of the second driver arm 23 is connected to the first polarity side of the alternating current power source. Right one of the second-pared driver electrodes 29 placed on the back main face of the second driver arm 23 is connected to the second polarity side of the alternating current power source. Left one of the first-pared driver electrodes 29 placed on the front main face of the third driver arm 24 is connected to the first polarity side of the alternating current power source. Right one of the first-pared driver electrodes 29 placed on the front main face of the third driver arm 24 is connected to the second polarity side of the alternating current power source. Left one of the second-pared driver electrodes 29 placed on the back main face of the third driver arm 24 is connected to the second polarity side of the alternating current power source. Right one of the second-pared driver electrodes 29 placed on the back main face of the third driver arm 24 is connected to the first polarity side of the alternating current power source. The driver electrodes 29 placed on the second driver arm 23 are opposite in polarity to the driver electrodes 29 placed on the first and third driver arm 22 and 24.

The detective electrodes 30 are also connected to the alternating current power source. First-two detective electrodes 30 provided on the front and back main faces of the second detective arm 26 are connected to a first polarity side of the alternating current power source. Second-two detective electrodes 30 provided on the right and left side faces of the second detective arm 26 are connected to a second polarity side of the alternating current power source. The two detective electrodes 30 provided on the opposite side faces of the second detective electrode 26 are connected to the same polarity side of the alternating current power source.

Operations of detecting the angular velocity of the rotating object by the second novel six-armed piezo-electric vibration gyroscope 21 will subsequently be described. An alternating current voltage is applied to the driver electrodes 29 thereby exciting electric fields represented by arrow marks in FIG. 18 in each of the first, second, and third driver arms 22, 23, and 24 which comprise piezo-electric material. This excitation of the electric fields in the first, second, and third driver arms 22, 23, and 24 causes mechanical pressures applied to the first, second, and third driver arms 22, 23, and 24. This mechanical pressures applied to the first, second, and third driver arms 22, 23, and 24 causes right and left displacements in the main plane of the first, second, and third driver arms 22, 23, and 24. The first and third driver arms 22 and 24 are identical with each other in direction of the excited electric field, for which reason the first and third driver arms 22 and 24 are identical with each other in direction of the displacement. As a result, the first and third driver arms 22 and 24 are identical with each other in phase of the in-plane vibration. The first and third driver arms 22 and 24 are, however, opposite to the second driver arm 23 in direction of the excited electric field, for which reason the first and third driver arms 22 and 24 are, however, opposite to the second driver arm 23 in direction of the displacement. As a result, the first and third driver arms 22 and 24 are, however, opposite to the second driver arm 23 in phase of the in-plane vibration. The second driver arm 23 shows the in-plane vibration which is different in phase by 180 degrees from the in-plane vibrations of the first and third driver arms 22 and 24, wherein the second driver arm 23 is opposite in direction of the displacement to the first and third driver arms 22 and 24. In accordance with the illustration, the displacements of the first, second, and third driver arms 22, 23, and 24 are emphasized so that the second driver arm 23 is close to the first driver arm 22. Notwithstanding, actually, however, the displacements are extremely small and it is never caused that the second driver arm 23 close to the first and third driver arms 22 and 24.

If the above six-armed piezo-electric vibration gyroscope 21 is placed on a rotating object which rotates around the Y-axis in FIG. 16 at an angular velocity Ω, the Coriolis force is applied to the first, second, and third driver arms 22, 23, and 24 in the direction vertical to the main face of the six-armed piezo-electric vibration gyroscope 21. The Coriolis force as applied to the first, second, and third driver arms 22, 23, and 24 causes that the first, second, and third driver arms 22, 23, and 24 show the vertical-to-plane vibrations, wherein the first and third driver arms 22 and 24 are identical with each other in phase of the vertical-to-plane vibrations, whilst the second driver arm 23 is different from the first and third driver arms 22 and 24 in phase of the vertical-to-plane vibrations by 180 degrees. Those vertical-to-plane vibrations of the first, second, and third driver arms 22, 23 and 24 propagate through the body 28 to the first, second, and third detective arms 25, 26, and 27 in the opposite side. As a result, it is cased that the first, second, and third detective arms 25, 26, and 27 the vertical-to-plane vibrations in the direction vertical to the main face of the six-armed piezo-electric vibration gyroscope 21, wherein the first and third detective arms 25 and 27 are identical with each other in phase of the vertical-to-plane vibrations, whilst the second detective arm 26 is different from the first and third detective arms 25 and 27 in phase of the vertical-to-plane vibrations by 180 degrees. The above in-plane vibration is the driving mode of the six-armed piezo-electric vibration gyroscope 21, whilst this vertical-to-plane vibration is the detecting mode of the six-armed piezo-electric vibration gyroscope 21. The displacements of the first, second, and third detective arms 25, 26, and 27 in the vertical-to-plane vibrations is larger in a few times than the displacements of the first and third driver arms 22, 23, and 24 in the vertical-to-plane vibrations. It is, however, important for the present invention that the body 28 has such a rectangle plate shape that a length size in a length direction is equal to or larger than a width size in a width direction. The length size is the size of the body 28 in the length direction, which is parallel to the longitudinal direction of the first, second third driver arms 22, 23, and 24, and the first, second, and third detective arms 25, 26, and 27. The width size is the size of the body 28 in the width direction, which is parallel to the first and second opposite sides of the body 28 and also which is perpendicular to the longitudinal direction of the first, second third driver arms 22, 23, and 24, and the first, second, and third detective arms 25, 26, and 27. The body 28 having the rectangle plate shape has a high in-plane stiffness in the plane direction. The above specific size and the high in-plane stiffness of the body 28 causes that the in-plane vibrations of the first, second, and third driver arms 22, 23, and 24 are almost not propagated to the opposite side first, second, and third detective arms 25, 26, and 27. The body 28 is intentionally designed to have the length size equal to or larger than the width size in order to prevent the propagation of the in-plane vibrations from the first, second, third driver arms 22, 23, and 24 toward the first, second, and third detective arms 25, 26, and 27. Accordingly, almost no in-plane vibration is excited to the first, second, and third detective arms 25, 26, and 27. The second detective arm 26 shows the vertical-to-plane vibration. The displacement of the second detective arm 26 in the vertical-to-plane vibration causes electric fields as represented by the arrow marks in FIG. 19. The electric fields caused in accordance with the displacement of the second detective arm 26 in the vertical-to-plane vibration cause potential variations of the detective electrodes 30 on the front and back main faces and the left and right side faces of the second detective arm 26, wherein the potential variations accord to the displacement of the second detective arm 26 in the vertical-to-plane vibration. An amplitude of the potential is measured to measure an angular velocity Ω of the rotating object around the Y-axis.

The in-plane vibration mode and the vertical-to-plane vibration mode of the six-armed piezo-electric vibration gyroscope 21, which have been analyzed by the finite element method. It was, however, confirmed that distributions of the actual in-plane vibration and the actual vertical-to-plane vibration, which have been actually measured by a laser Doppler vibro-meter well correspond to the above analyzed in-plane and vertical-to-plane vibration modes.

The six-armed piezo-electric vibration gyroscope 21 was prepared as follows. A plate of the six-armed piezo-electric vibration gyroscope 21 was cut from the X-cut Langer site plate by a wire-cutting method. An evaporation and a photo-resist method was carried out to selectively form Au/Cr evaporation electrodes which serve as the driver electrodes 29 and the detective electrodes 30.

In order to suppress any noise vibration which is different from the above in-plane vibration in the driver mode and the above vertical-to-plane vibration in the detective mode, it is preferable that the six-armed piezo-electric vibration gyroscope 21 is symmetrically designed with reference to both the top and bottom directions and also the right and left directions and also that the first, second, and third driver arms 22, 23, and 24, the first, second, and third detective arms 25, 26, and 27 and the body 28 have the same length. If the six-armed piezo-electric vibration gyroscope 21 is largely different in shape from the above symmetrical and uniform-length shape, then undesirable vibration having a different frequency from a resonant frequency of the in-plane vibration and also from a resonant frequency of the vertical-to-plane vibration, whereby a spurious response appears. The above symmetrical and uniform-length shape of the six-armed piezo-electric vibration gyroscope 21 allows the six-armed piezo-electric vibration gyroscope 21 to have spurious response free desirable frequency responsibility and high speed responsibility. It is, for example, possible that the first, second, and third driver arms 22, 23, and 24, the first, second, and third detective arms 25, 26, and 27 and the body 28 have the same thickness of 0.32 mm. The first, second, and third driver arms 22, 23, and 24, and the first, second, and third detective arms 25, 26, and 27 have the same width of 0.3 mm and the same length of 4.0 mm. The body 28 has a length of 3.2 mm and a width of 3.0 mm.

In order to excite the in-plane vibration of the first, second, and third driver arms 22, 23, and 24 at a possible high frequency upon voltage application to the driver electrodes 29, it is preferable that the driver electrodes 29 has such a size as possible increase the effective electromechanical coupling coefficient. A inter-relationship between the effective electromechanical coupling coefficient and the size of the driver electrode 29 will be described. The body 28 is sufficiently larger in stiffness than the first, second, and third driver arms 22, 23, and 24. For this reason, each of the first, second, and third driver arms 22, 23, and 24 may be considered to be a one-side supported beam. The inter-relationship between the effective electromechanical coupling coefficient and the size of the driver electrode 29 was investigated as follows. It is assumed that the driver electrode 29 has a width “We” and a length “Le”, and the second driver arm 23 has a width “Wa” and a length “La”. A ratio of “We”/“Wa” is kept constant at 0.7, whilst a ratio of “Le”/“La” is changed from 0 to 1. At this time, variations in the effective electromechanical coupling coefficient as a relative value versus the ratio “Le”/“La” was investigated. The effective electromechanical coupling coefficient is high in the range of the ratio “Le”/“La” from 0.4 to 0.6. The ratio “We”/“Wa” is changed from 0 to 1, whilst a ratio of “Le”/“La” is kept constant at 0.6. At this time, variations in the effective electromechanical coupling coefficient as a relative value versus the ratio “We”/“Wa” was investigated. The effective electromechanical coupling coefficient is high in the range of the ratio “We”/“Wa” from 0.3 to 0.5. Consequently, in order to obtain possible high effective electromechanical coupling coefficient, it is preferable that the driver electrodes 29 are in the range of length from 40% to 70% of the first, second, and third driver arms 22, 23, and 24, and that the driver electrodes 29 are in the range of width from 30% to 50% of the first, second, and third driver arms 22, 23, and 24.

In order to excite the in-plane vibration of the second detective arm 26 at a possible high frequency upon voltage application to the detective electrodes 30, it is preferable that the detective electrodes 30 has such a size as possible increase the effective electromechanical coupling coefficient. A inter-relationship between the effective electromechanical coupling coefficient and the size of the detective electrode 30 will be described. The body 28 is sufficiently larger in stiffness than the second detective arm 26. For this reason, each of the second detective arm 26 may be considered to be a one-side supported beam. The inter-relationship between the effective electromechanical coupling coefficient and the size of the detective electrode 30 was investigated as follows. It is assumed that the detective electrode 30 has a width “Wev” and a length “Lev”, and the second detective arm 26 has a width “Wav” and a length “Lav”. A ratio of “Wev”/“Wav” is kept constant at 0.5, whilst a ratio of “Lev”/“Lav” is changed from 0 to 1. At this time, variations in the effective electromechanical coupling coefficient as a relative value versus the ratio “Lev”/“Lav” was investigated. The effective electromechanical coupling coefficient is high in the range of the ratio “Lev”/“Lav” from 0.4 to 0.7. The ratio “Wev”/“Wav” is changed from 0 to 1, whilst the ratio “Lev”/“Lav” is kept constant at 0.6. At this time, variations in the effective electromechanical coupling coefficient as a relative value versus the ratio “Wev”/“Wav” was investigated. The effective electromechanical coupling coefficient is high in the range of the ratio “Wev”/“Wav” from 0.4 to 0.7. Consequently, in order to obtain possible high effective electromechanical coupling coefficient, it is preferable that the detective electrodes 30 are in the range of length from 40% to 70% of the second detective arm 26, and that the detective electrodes 30 are in the range of width from 40% to 70% of the second detective arm 26.

If a difference between the resonant frequency of the in-plane vibration in the driver mode and the resonant frequency of the vertical-to-plane vibration in the detective mode is extremely small, then the sensitivity of the six-armed piezo-electric vibration gyroscope 21 is high but influences of noises caused by transitional variations in angular velocity due to external vibration is relatively large. In order to allow the six-armed piezo-electric vibration gyroscope 21 to have good frequency responsibility and high sensitivity, it is effective to do the de-tuning so as to increase the difference between the resonant frequency of the in-plane vibration in the driver mode and the resonant frequency of the vertical-to-plane vibration in the detective mode. It is assumed that the six-armed piezo-electric vibration gyroscope 21 is mounted on an automobile. In this case, it is preferable that the difference between the resonant frequency of the in-plane vibration in the driver mode and the resonant frequency of the vertical-to-plane vibration in the detective mode is about 100 Hz. In this example, this difference is set at 103 Hz. One method of how to tune the difference between the resonant frequency of the in-plane vibration in the driver mode and the resonant frequency of the vertical-to-plane vibration in the detective mode will be investigated. Four corners of the rectangle-shaped body 28 are cut by a laser. If the four corners of the body 28 are cut, then both the resonant frequency of the in-plane vibration in the driver mode and the resonant frequency of the vertical-to-plane vibration in the detective mode are decreased, wherein the amount of the decrease of the resonant frequency of the in-plane vibration in the driver mode is larger than the amount of the decrease of the resonant frequency of the vertical-to-plane vibration in the detective mode. Namely, the difference between the resonant frequency of the in-plane vibration in the driver mode and the resonant frequency of the vertical-to-plane vibration in the detective mode is tunable by cutting the four corners of the body 28. Another method of how to tune the difference between the resonant frequency of the in-plane vibration in the driver mode and the resonant frequency of the vertical-to-plane vibration in the detective mode will be investigated. The top of the second driver arm 23 positioned at the center and the top of the second detective arm 26 positioned at the center are cut by a laser. If the top of the second driver arm 23 positioned at the center and the top of the second detective arm 26 positioned at the center are cut, then both the resonant frequency of the in-plane vibration in the driver mode and the resonant frequency of the vertical-to-plane vibration in the detective mode are increased, wherein the amount of the increase of the resonant frequency of the vertical-to-plane vibration in the detective mode is larger than the amount of the increase of the resonant frequency of the in-plane vibration in the driver mode. Namely, the difference between the resonant frequency of the in-plane vibration in the driver mode and the resonant frequency of the vertical-to-plane vibration in the detective mode is tunable by cutting the top of the second driver arm 23 positioned at the center and the top of the second detective arm 26 positioned at the center.

The six-armed piezo-electric vibration gyroscope 21 is symmetrical in shape with reference to both the top and bottom directions and the right and left directions. For this reason, a vibration displacement at the gravity center of the six-armed piezo-electric vibration gyroscope 21 in vibration is extremely small, for example, not more than 1/10000 of the maximum vibration displacement of the first, second, and third driver arms 22, 23, and 24, and the first, second, and third detective arms 25, 26, and 27. This means it possible to realize a highly stable support of the six-armed piezo-electric vibration gyroscope 21 at its gravity center. The six-armed piezo-electric vibration gyroscope 21 is supported by a supporter at a position of gravity center. The supporter may comprise a quartz glass. The supporter has a diameter of 1 mm and a height of 1 mm. If the six-armed piezo-electric vibration gyroscope 21 is supported by the supporter at its gravity center, then the mechanical quality factor of the six-armed piezo-electric vibration gyroscope 21 is reduced but only about 30%. Variations, by the support, in both the resonant frequency of the in-plane vibration in the driver mode and the resonant frequency of the vertical-to-plane vibration in the detective mode are only within 10 Hz. The six-armed piezo-electric vibration gyroscope 21 was supported by the supporter at its gravity center for detecting the angular velocity. A detective sensitivity was high at 0.78 mV/(deg/s).

In accordance with the six-armed piezo-electric vibration gyroscope 21, as described above, the first and third driver arms 22 and 24 show the in-plane vibration of the driver mode in the same phase and the second driver arm 23 shows the in-plane vibration of the driver mode in the opposite phase to the first and third driver arms 22 and 24. The Coriolis force is effected to the in-plane vibrations of the first, second, and third driver arms 22, 23, and 24, thereby exciting the vertical-to-plane vibration on the first, second, and third driver arms 22, 23, and 24. This vertical-to-plane vibration of the first, second, and third driver arms 22, 23, and 24 is then propagated through the body 28 to the first, second, and third detective arms 25, 26, and 27. The in-plane vibration of the first, second, and third driver arms 22, 23, and 24 is almost not propagated through the body 28 to the first, second, and third detective arms 25, 26, and 27, whereby the first, second, and third detective arms 25, 26, and 27 show the vertical-to-plane vibration as the detective mode without the in-plane vibration as the driver mode. Almost no mechanical coupling between the driver mode in-plane vibration and the detective mode vertical-to-plane vibration appears on the first, second, and third detective arms 25, 26, and 27. The detective mode vertical-to-plane vibration is detectable at high sensitivity and a high signal-to-noise ratio by the first, second, and third detective arms 25, 26, and 27.

The first, second, and third driver arms 22, 23, and 24 are distanced by the body 28 from the first, second, and third detective arms 25, 26, and 27, for which reason an electrostatic coupling is unlikely to appear, and this allows a highly sensitive detection at a high signal-to-noise ratio.

The vibration displacements of the first, second, and third detective arms 25, 26, and 27 are larger by a few times than the vibration displacements of the first, second, and third driver arms 22, 23, and 24.

In the above described embodiment, the piezo-electric material comprises the X-cut Langer site. It is, however, possible that the piezo-electric material comprises the X-cut crystal, 130 degrees rotating Y-plate lithium tantalate, and a piezo-electric ceramic plate uniformly polarized in thickness direction.

In the above described embodiment, the detective electrodes 30 are provided on the second detective arm 26 positioned at center between the first and third detective arms 25 and 27 for detecting the detective mode vertical-to-plane vibration. It is, however, possible that the detective electrodes 30 are provided on the first and third detective arms 25 and 27 for detecting the detective mode vertical-to-plane vibration. It is also possible that the detective electrodes 30 are provided on the first, second and third detective arms 25, 26, and 27 for detecting the detective mode vertical-to-plane vibration.

In the above described embodiment, a first set of the first, second and third driver arms 22, 23, and 24 and a second set of the first, second, and third detective arms 25, 26, and 27 are positioned at opposite sides of the body 10 and the first, second, and third driver arms 22, 23, and 24 extend in the anti-parallel directions to the first, second, and third detective arms 25, 26, and 27 The above six-armed shape may be changeable provided that the driver arms and the detective arms are separated by the body from each other, and the in-plane vibration parallel to the main face of the body of the piezo-electric vibration gyroscope is excited on the driver arms, and propagation of the in-plane vibration of the driver arms to the detective arms is suppressed.

As described above, the piezo-electric vibration gyroscope in accordance with the present invention is capable of detecting the angular velocity at a high signal-to-noise ratio. The piezo-electric vibration gyroscope is superior in resolving power, for example, enable to detect a smaller angular velocity than the spin of the earth. Further, the piezo-electric vibration gyroscope is supported by the supporter at its gravity center. Further, the shapes of the driver electrodes and the detective electrodes are optimized so as to obtain the large effective electromechanical coupling coefficient between the driver arms and the detective arms. The displacement of the detective arms in the vibrations is larger by a few times than the displacement of the driver arms in the vibrations, for which reason the piezo-electric vibration gyroscope is capable of detecting the angular velocity at high sensitivity.

Whereas modifications of the present invention will be apparent to a person having ordinary skill in the art, to which the invention pertains, it is to be understood that embodiments as shown and described by way of illustrations are by no means intended to be considered in a limiting sense. Accordingly, it is to be intended to cover by claims all modifications, which fall within the spirit and scope of the present invention.

What is claimed is:

1. A piezo-electric vibration gyroscope comprising:
a body of a rectangle plate shape defined by a first size in a length direction and a second size in a width direction;
plural driver arms extending from a first side of said body in said length direction and also extending in the same plane as said body;
plural detective arms extending from a second side opposite to said first side of said body in an anti-parallel direction to said length direction and also extending in the same plane as said body;
plural driver electrodes being provided on said plural driver arms and being applied with an alternating current voltage for causing said plural driver electrodes to show an in-plane vibration of a driving mode in said width direction included in said plane;
plural detecting electrodes on at least one of said plural detective arms for detecting a voltage caused by a vertical-to-plane vibration of a detective mode in a vertical direction to said plane,
wherein said first size of said body is equal to or larger than said second size of said body for allowing said vertical-to-plane vibration of said detective mode to propagate from said plural driver arms through said body to said plural detective electrodes and for preventing said in-plane vibration of said driving mode from propagating from said plural driver arms through said body to said plural detective electrodes.

2. The piezo-electric vibration gyroscope as claimed in claim 1, wherein said body has a higher stiffness in the same direction as said in-plane vibration than other stiffness in other directions.

3. The piezo-electric vibration gyroscope as claimed in claim 1, wherein the number of said plural driver arms is the same as the number of said plural detective arms.

4. The piezo-electric vibration gyroscope as claimed in claim 3, wherein said piezo-electric vibration gyroscope is symmetrical both in said length direction and said width direction.

5. The piezo-electric vibration gyroscope as claimed in claim 4, wherein a center driver arm in said plural driver arms and a center detective arm in said plural detective arms are aligned on a longitudinal center axis parallel to said length direction.

6. The piezo-electric vibration gyroscope as claimed in claim 4, wherein said plural driver arms and said plural detective arms have the same length.

7. The piezo-electric vibration gyroscope as claimed in claim 4, wherein said plural driver arms comprise three driver arms and said plural detective arms comprise three detective arms.

8. The piezo-electric vibration gyroscope as claimed in claim 7, wherein a center driver arm in said three driver arms and a center detective arm in said three detective arms are aligned on a longitudinal center axis parallel to said length direction.

9. The piezo-electric vibration gyroscope as claimed in claim 7, wherein said three driver arms and said three detective arms have the same length and have the same width.

10. The piezo-electric vibration gyroscope as claimed in claim 7, wherein four driver electrodes are provided on front and back main faces and right and left side faces of each of said three driver arms, and first-paired detective electrodes are provided on a front face of said center detective electrode and second-pared detective electrodes are provided on a back face of said center detective electrode.

11. The piezo-electric vibration gyroscope as claimed in claim 10, wherein each of said driver electrodes has a longitudinal center axis which is aligned to a longitudinal center axis of said driver arm, and each of said driver electrodes ha s a width smaller than a width of each of said driver arms, and each of said detective electrodes extends along a side edge of said center detective arm and each of said detective electrodes has a smaller width than a half width of said center detective arm.

12. The piezo-electric vibration gyroscope as claimed in claim 11, wherein said driver electrodes have the same width and the same length, and said detective electrodes have the same width and the same length.

13. The piezo-electric vibration gyroscope as claimed in claim 12, wherein said driver electrodes have a width which is in the range of 50% -70% of a width of each of said driver arms, and a length which is in the range of 40%-70% of a length of each of said driver arms, and each of said first-pared detective electrodes on said right side face of said center detective arm and said second-pared detective electrodes on said left side face of said second detective arm has a total width which is in the range of 30%-50% of a width of said center detective arm, and said detective electrodes have a length in the range of 40%-70% of a length of said center detective electrode.

14. The piezo-electric vibration gyroscope as claimed in claim 10, wherein first-paired two of said four driver electrodes provided on the front and back main faces of each of side two driver arms of said three driver arms are connected to a first polarity side of an alternating current power source, and second-paired two of said four driver electrodes provided on the right and left side faces of each of side two driver arms of said three driver arms are connected to a second polarity side of said alternating current power source, and first-paired two of said four driver electrodes provided on the front and back main faces of said center driver arm of said three driver arms are connected to the second polarity side of the alternating current power source, and second-paired two of said four driver electrodes provided on the right and left side faces of said center driver arm of said three driver arms are connected to the first polarity side of said alternating current power source, and two of said four detective electrodes diagonally positioned are connected to said first polarity side of the alternating current power source, and remaining two of said four detective electrodes diagonally positioned are connected to said second polarity side of the alternating current power source.

15. The piezo-electric vibration gyroscope as claimed in claim 14, wherein the in-plane vibration of said center driver arm is different in phase by 180 degrees from the in-plane vibration of said two side driver arms.

16. The piezo-electric vibration gyroscope as claimed in claim 15, wherein the vertical-to-plane vibration of said center detective arm is different in phase by 180 degrees from the vertical-to-plane vibration of said two side detective arms.

17. The piezo-electric vibration gyroscope as claimed in claim 7, wherein four detective electrodes are provided on front and back main faces and right and left side faces of each of said three detective arms, and first-paired driver electrodes are provided on a front face of said center driver electrode and second-pared driver electrodes are provided on a back face of said center driver electrode.

18. The piezo-electric vibration gyroscope as claimed in claim 17, wherein each of said detective electrodes has a longitudinal center axis which is aligned to a longitudinal center axis of said detective arm, and each of said detective electrodes has a width smaller than a width of each of said detective arms, and each of said driver electrodes extends along a side edge of said center driver arm and each of said driver electrodes has a smaller width than a half width of said center driver arm.

19. The piezo-electric vibration gyroscope as claimed in claim 18, wherein said detective electrodes have the same width and the same length, and said driver electrodes have the same width and the same length.

20. The piezo-electric vibration gyroscope as claimed in claim 19, wherein said detective electrodes have a width which is in the range of 50%-70% of a width of each of said detective arms, and a length which is in the range of 40%-70% of a length of each of said detective arms, and each of said first-pared driver electrodes on said right side face of said center driver arm and said second-pared driver electrodes on said left side face of said second driver arm has a total width which is in the range of 30% -50% of a width of said center driver arm, and said driver electrodes have a length in the range of 40%-70% of a length of said center driver electrode.

21. The piezo-electric vibration gyroscope as claimed in claim 17, wherein first-paired two of said four detective electrodes provided on the front and back main faces of each of side two detective arms of said three detective arms are connected to a first polarity side of an alternating current power source, and second-paired two of said four detective electrodes provided on the right and left side faces of each of side two detective arms of said three detective arms are connected to a second polarity side of said alternating current power source, and first-paired two of said four detective electrodes provided on the front and back main faces of said center detective arm of said three detective arms are connected to the second polarity side of the alternating current power source, and second-paired two of said four detective electrodes provided on the right and left side faces of said center detective arm of said three driver arms are connected to the first polarity side of said alternating current power source, and two of said four driver electrodes diagonally positioned are connected to said first polarity side of the alternating current power source, and remaining two of said four driver electrodes diagonally positioned are connected to said second polarity side of the alternating current power source.

22. The piezo-electric vibration gyroscope as claimed in claim 21, wherein the in-plane vibration of said center driver arm is different in phase by 180 degrees from the in-plane vibration of said two side driver arms.

23. The piezo-electric vibration gyroscope as claimed in claim 22, wherein the vertical-to-plane vibration of said center detective arm is different in phase by 180 degrees from the vertical-to-plane vibration of said two side detective arms.

24. The piezo-electric vibration gyroscope as claimed in claim 1, wherein entire parts of said piezo-electric vibration gyroscope have a uniform thickness.

25. The piezo-electric vibration gyroscope as claimed in claim 1, wherein a single supporter is mechanically connected to at a gravity center position of said piezo-electric vibration gyroscope.

26. The piezo-electric vibration gyroscope as claimed in claim 25, wherein said supporter extends from said gravity center position in a vertical direction to said plane of said piezo-electric vibration gyroscope.

27. The piezo-electric vibration gyroscope as claimed in claim 1, wherein said body has a just rectangle shape having right-angled four corners.

28. The piezo-electric vibration gyroscope as claimed in claim 1, wherein said body has a generally rectangle shape having cut four corners.

29. The piezo-electric vibration gyroscope as claimed in claim 1, wherein both a top of a center driver arm in said plural driver arms and a top of a center detective arm in said plural detective arms are cut, so that said center driver arm and said center detective arm are shorter than remaining arms of said plural driver and detective arms.

30. The piezo-electric vibration gyroscope as claimed in claim 1, wherein each of said plural driver arms and said plural detective arms has a square-shaped section in a plane vertical to said length direction.

31. A piezo-electric vibration gyroscope comprising:
a body of a rectangle plate shape defined by a first size in a length direction and a second size in a width direction;
plural driver arms extending from a first side of said body in said length direction and also extending in the same plane as said body;
plural detective arms extending from a second side opposite to said first side of said body in an anti-parallel direction to said length direction and also extending in the same plane as said body;
plural driver electrodes being provided on said plural driver arms and being applied with an alternating current voltage for causing said plural driver electrodes to show an in-plane vibration of a driving mode in said width direction included in said plane;
plural detecting electrodes on at least one of said plural detective arms for detecting a voltage caused by a vertical-to-plane vibration of a detective mode in a vertical direction to said plane,
wherein a single supporter is mechanically connected to at a gravity center position of said piezo-electric vibration gyroscope.

32. The piezo-electric vibration gyroscope as claimed in claim 31, wherein said supporter extends from said gravity center position in a vertical direction to said plane of said piezo-electric vibration gyroscope.

33. The piezo-electric vibration gyroscope as claimed in claim 31, wherein said first size of said body is equal to or larger than said second size of said body for allowing said vertical-to-plane vibration of said detective mode to propagate from said plural driver arms through said body to said plural detective electrodes and for preventing said in-plane vibration of said driving mode from propagating from said plural driver arms through said body to said plural detective electrodes.

34. The piezo-electric vibration gyroscope as claimed in claim 33, wherein said body has a higher stiffness in the same direction as said in-plane vibration than other stiffness in other directions.

35. The piezo-electric vibration gyroscope as claimed in claim 33, wherein the number of said plural driver arms is the same as the number of said plural detective arms.

36. The piezo-electric vibration gyroscope as claimed in claim 35, wherein said piezo-electric vibration gyroscope is symmetrical both in said length direction and said width direction.

37. The piezo-electric vibration gyroscope as claimed in claim 36, wherein a center driver arm in said plural driver arms and a center detective arm in said plural detective arms are aligned on a longitudinal center axis parallel to said length direction.

38. The piezo-electric vibration gyroscope as claimed in claim 36, wherein said plural driver arms and said plural detective arms have the same length.

39. The piezo-electric vibration gyroscope as claimed in claim 36, wherein said plural driver arms comprise three driver arms and said plural detective arms comprise three detective arms.

40. The piezo-electric vibration gyroscope as claimed in claim 39, wherein a center driver arm in said three driver arms and a center detective arm in said three detective arms are aligned on a longitudinal center axis parallel to said length direction.

41. The piezo-electric vibration gyroscope as claimed in claim 39, wherein said three driver arms and said three detective arms have the same length and have the same width.

42. The piezo-electric vibration gyroscope as claimed in claim 39, wherein four driver electrodes are provided on front and back main faces and right and left side faces of each of said three driver arms, and first-paired detective electrodes are provided on a front face of said center detective electrode and second-pared detective electrodes are provided on a back face of said center detective electrode.

43. The piezo-electric vibration gyroscope as claimed in claim 42, wherein each of said driver electrodes has a longitudinal center axis which is aligned to a longitudinal center axis of said driver arm, and each of said driver electrodes has a width smaller than a width of each of said driver arms, and each of said detective electrodes extends along a side edge of said center detective arm and each of said detective electrodes has a smaller width than a half width of said center detective arm.

44. The piezo-electric vibration gyroscope as claimed in claim 43, wherein said driver electrodes have the same width and the same length, and said detective electrodes have the same width and the same length.

45. The piezo-electric vibration gyroscope as claimed in claim 44, wherein said driver electrodes have a width which is in the range of 50% 70% of a width of each of said driver arms, and a length which is in the range of 40%-70% of a length of each of said driver arms, and each of said first-pared detective electrodes on said right side face of said center detective arm and said second-pared detective electrodes on said left side face of said second detective arm has a total width which is in the range of 30%-50% of a width of said center detective arm, and said detective electrodes have a length in the range of 40%-70% of a length of said center detective electrode.

46. The piezo-electric vibration gyroscope as claimed in claim 42, wherein first-paired two of said four driver electrodes provided on the front and back main faces of each of side two driver arms of said three driver arms are connected to a first polarity side of an alternating current power source, and second-paired two of said four driver electrodes provided on the right and left side faces of each of side two driver arms of said three driver arms are connected to a second polarity side of said alternating current power source, and first-paired two of said four driver electrodes provided on the front and back main faces of said center driver arm of said three driver arms are connected to the second polarity side of the alternating current power source, and second-paired two of said four driver electrodes provided on the right and left side faces of said center driver arm of said three driver arms are connected to the first polarity side of said alternating current power source, and two of said four detective electrodes diagonally positioned are connected to said first polarity side of the alternating current power source, and remaining two of said four detective electrodes diagonally positioned are connected to said second polarity side of the alternating current power source.

47. The piezo-electric vibration gyroscope as claimed in claim 46, wherein the in-plane vibration of said center driver arm is different in phase by 180 degrees from the in-plane vibration of said two side driver arms.

48. The piezo-electric vibration gyroscope as claimed in claim 47, wherein the vertical-to-plane vibration of said center detective arm is different in phase by 180 degrees from the vertical-to-plane vibration of said two side detective arms.

49. The piezo-electric vibration gyroscope as claimed in claim 39, wherein four detective electrodes are provided on front and back main faces and right and left side faces of each of said three detective arms, and first-paired driver electrodes are provided on a front face of said center driver electrode and second-pared driver electrodes are provided on a back face of said center driver electrode.

50. The piezo-electric vibration gyroscope as claimed in claim 49, wherein each of said detective electrodes has a longitudinal center axis which is aligned to a longitudinal center axis of said detective arm, and each of said detective electrodes has a width smaller than a width of each of said detective arms, and each of said driver electrodes extends along a side edge of said center driver arm and each of said driver electrodes has a smaller width than a half width of said center driver arm.

51. The piezo-electric vibration gyroscope as claimed in claim 50, wherein said detective electrodes have the same width and the same length, and said driver electrodes have the same width and the same length.

52. The piezo-electric vibration gyroscope as claimed in claim 51, wherein said detective electrodes have a width which is in the range of 50%-70% of a width of each of said detective arms, and a length which is in the range of 40%-70% of a length of each of said detective arms, and each of said first-pared driver electrodes on said right side face of said center driver arm and said second-pared driver electrodes on said left side face of said second driver arm has a total width which is in the range of 30%-50% of a width of said center driver arm, and said driver electrodes have a length in the range of 40%-70% of a length of said center driver electrode.

53. The piezo-electric vibration gyroscope as claimed in claim 49, wherein first-paired two of said four detective electrodes provided on the front and back main faces of each of side two detective arms of said three detective arms are connected to a first polarity side of an alternating current power source, and second-paired two of said four detective electrodes provided on the right and left side faces of each of side two detective arms of said three detective arms are connected to a second polarity side of said alternating current power source, and first-paired two of said four detective electrodes provided on the front and back main faces of said center detective arm of said three detective arms are connected to the second polarity side of the alternating current power source, and second-paired two of said four detective electrodes provided on the right and left side faces of said center detective arm of said three driver arms are connected to the first polarity side of said alternating current power source, and two of said four driver electrodes diagonally positioned are connected to said first polarity side of the alternating current power source, and remaining two of said four driver electrodes diagonally positioned are connected to said second polarity side of the alternating current power source.

54. The piezo-electric vibration gyroscope as claimed in claim 53, wherein the in-plane vibration of said center driver arm is different in phase by 180 degrees from the in-plane vibration of said two side driver arms.

55. The piezo-electric vibration gyroscope as claimed in claim 54, wherein the vertical-to-plane vibration of said center detective arm is different in phase by 180 degrees from the vertical-to-plane vibration of said two side detective arms.

56. The piezo-electric vibration gyroscope as claimed in claim 31, wherein entire parts of said piezo-electric vibration gyroscope have a uniform thickness.

57. The piezo-electric vibration gyroscope as claimed in claim 31, wherein said body has a just rectangle shape having right-angled four corners.

58. The piezo-electric vibration gyroscope as claimed in claim 31, wherein said body has a generally rectangle shape having cut four corners.

59. The piezo-electric vibration gyroscope as claimed in claim 31, wherein both a top of a center driver arm in said plural driver arms and a top of a center detective arm in said plural detective arms are cut, so that said center driver arm and said center detective arm are shorter than remaining arms of said plural driver and detective arms.

60. The piezo-electric vibration gyroscope as claimed in claim 31, wherein each of said plural driver arms and said plural detective arms has a square-shaped section in a plane vertical to said length direction.
